(19) United States
(12) Patent Application Publication
(10) Pub. No.: US 2024/0264460 A1
(43) Pub. Date: Aug. 8, 2024

(54) Serpentine Integrated Grating and Associated Devices

(71) Applicants: THE REGENTS OF THE UNIVERSITY OF COLORADO, A BODY CORPORATE, Denver, CO (US); TRUSTEES OF BOSTON UNIVERSITY, Boston, MA (US)

(72) Inventors: Kelvin Wagner, Boulder, CO (US); Nathan Dostart, Hampton, VA (US); Michael P. Brand, Boulder, CO (US); Milos Popovic, Lexington, MA (US); Bohan Zhang, Allston, MA (US)

(21) Appl. No.: 18/289,878

(22) PCT Filed: May 9, 2022
(86) PCT No.: PCT/US2022/028376

§ 371 Date: Nov. 7, 2023

Related U.S. Application Data
(60) Provisional application No. 63/185,631, filed on May 7, 2021.

(51) Int. Cl. G02B 27/42; G01J 3/02; G01J 3/18; G01J 3/28; G02B 5/18

(52) U.S. Cl. CPC G02B 27/4272; G01J 3/0259; G01J 3/1804; G01J 3/2803; G02B 5/188

(57) ABSTRACT

A serpentine integrated grating spectrometer includes a serpentine delay line and a plurality of grating couplers. The serpentine delay line includes a plurality of parallel waveguide segments that are coplanar in a delay-line plane. The serpentine delay line serially connects each of the plurality of grating couplers. Each of the plurality of grating couplers (i) is located at a respective one of the plurality of parallel waveguide segments, and (ii) direct light propagating in the serpentine delay line out of the delay-line plane. The plurality of waveguide segments is M in number and impart a total group delay time ry on light propagating therethrough. Each of the plurality of grating couplers impart a grating coupler delay tₓ on light propagating therethrough that exceeds (t_{y}/M), the time delay for a single segment of the M parallel segments.

### CROSS-REFERENCE TO RELATED APPLICATIONS

This application claims the benefit of U.S. Provisional Application No. 63/185,631, filed on May 7, 2021, the disclosure of which is incorporated herein by reference in its entirety.

### BACKGROUND

Integrated spectrometers are integrated variants of conventional free-space spectrometers that offer significantly reduced size, weight, and cost, immunity to alignment errors, and can be readily integrated with other instruments such as nulling interferometers or polarimeters. Current integrated dispersive spectrometers are one-dimensional devices such as arrayed waveguide gratings or planar echelle gratings. These devices have been limited to 10⁴ resolving powers and less than 1000 spectral bins due to having limited total differential optical delay paths and 1D detector array pixel densities.

### SUMMARY

In a first aspect, a serpentine integrated grating includes a serpentine delay line and a plurality of grating couplers. The serpentine delay line includes a plurality of parallel waveguide segments that are coplanar in a delay-line plane. The serpentine delay line serially connects each of the plurality of grating couplers. Each of the plurality of grating couplers (i) is located at a respective one of the plurality of parallel waveguide segments, and (ii) direct light propagating in the serpentine delay line out of the delay-line plane. The plurality of waveguide segments is M in number and impart a total group delay time τ_{y} on light propagating therethrough. Each of the plurality of grating couplers impart a grating coupler delay τₓ on light propagating therethrough that exceeds (τ_{y}/M), the time delay for a single segment of the M parallel segments.

In a second aspect, a serpentine integrated grating includes a serpentine delay line, a plurality of grating couplers, and a plurality of optical couplers. The serpentine delay line includes a plurality of parallel waveguide segments intersecting a delay-line plane. The serpentine delay line serially connects each of the plurality of grating couplers. At least part of each of the plurality of grating couplers is located directly above a respective one of the plurality of waveguide segments. Each of the plurality of optical couplers is located between a respective one of the plurality of waveguide segments and a respective one of the plurality of grating couplers located thereabove.

### BRIEF DESCRIPTION OF THE FIGURES

FIG. 1 is a schematic of cross-dispersion free-space optics used in a spectrometer.

FIG. 2 is schematic of a crossed-dispersion spectrometer that includes the free-space optics of FIG. 1.

FIG. 3 is a schematic of serpentine delay line a grating coupler, and a lens of embodiments of a serpentine integrated grating (SIG) spectrometer.

FIG. 4 is a schematic of a SIG spectrometer, which includes components described in FIG. 3, in an embodiment.

FIG. 5 is a schematic of a grating coupler, which is an example of the grating coupler of FIG. 3.

FIGS. 6 and 7 are schematics of respective SIGs, each of which is an example of a SIG of the SIG spectrometer of FIG. 4.

FIG. 8 is a schematic of a SIG spectrometer that includes twelve SIGs integrated onto a SIG chip, in an embodiment.

FIG. 9 includes images of the SIG chip of FIG. 8.

FIG. 10 shows an example composite image of calibration data associated with an embodiment of the SIG spectrometer of FIG. 4.

FIG. 11 shows reconstructed spectra of two detuned laser lines, from which spectral resolution of embodiments of the SIG spectrometer of FIG. 4 may be determined.

FIG. 12 is a power spectrum showing a bandwidth of an embodiments of the SIG spectrometer of FIG. 4.

FIG. 13 is a schematic of a multimode spectrometer with high-etendue, which in an embodiment of the SIG spectrometer of FIG. 4.

FIG. 14 is a schematic plan view of a focusing SIG, which is an embodiment of the SIG of FIG. 4.

FIG. 15 is a schematic plan view of a that SIG has a linearly varying time delay, in an embodiment.

FIG. 16 shows focusing of light emitted by a focusing SIG, which is an example of the SIG of FIG. 14.

FIG. 17 is a schematic of a multi-level SIG, which is an embodiment of the SIG of FIG. 4.

FIG. 18 is a cross-sectional view of the multi-level SIG of FIG. 17. schematic of a serpentine integrated grating spectrometer, in an embodiment.

FIG. 19 is a schematic of a two-dimensional crossed-dispersive SIGS spectrometer, which includes example of a SIG of FIG. 4, in an embodiment.

FIG. 20 is a plan view of a multi-level focusing SIG, which is an example of the SIG of FIG. 17.

FIG. 21 is a schematic of a multimode spectrometer with high-etendue, which in an example SIG spectrometer of FIG. 13.

### DETAILED DESCRIPTION OF THE EMBODIMENTS

Embodiments disclosed herein include a high-resolution and compact serpentine integrated grating (SIG) spectrometer design based on a 2-D dispersive serpentine optical phased array (SOPA). The SIG device combines a folded delay line with grating couplers to create a large optical delay path along two dimensions in a compact integrated device footprint. Analogously to free-space crossed-dispersion high-resolution spectrometers, but for the first time using a single integrated photonic device manifesting both coarse and fine axis of dispersion, the SIG spectrometer maps spectral content to a 2-D wavelength-beamsteered folded-raster emission pattern that is focused onto a 2-D detector array.

An embodiment of the SIG spectrometer has ˜100 k resolving power and ˜6750 spectral bins, which are approximately an order of magnitude higher than previous integrated photonic designs that operate over a wide bandwidth, in a 0.4 mm² footprint. We measure a Rayleigh resolution of 1.93±0.07 GHz and an operational bandwidth from 1540 nm to 1650 nm. These results show that SIG spectrometer technology provides a path toward miniaturized, high-resolution spectrometers for applications in astronomy and beyond.

### 1. Introduction

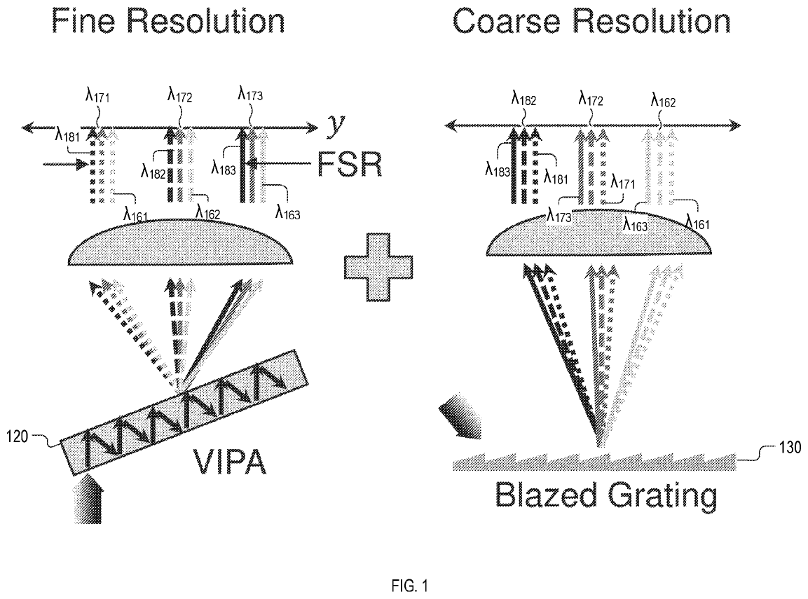

Spectroscopy plays a key role in numerous areas of science and technology. Many advanced high-resolution spectrometers use crossed-dispersion free-space optics to image spectral content across a 2-D detector array. FIG. 1 is a schematic of such cross-dispersion free-space optics, which include a high-dispersion optics 120. These spectrometers simultaneously measure tens to hundreds of thousands of spectral bins, achieving high resolving power, wide bandwidth, and high sensitivity all at once. The resolving power R=ω₀/Δω=τv₀ is given by the maximum time delay τ across the dispersive optical components divided by the optical period: higher resolving powers require larger time delays.

To maximize time delay, these spectrometers use high-dispersion optic 120, such as an echelle grating or virtually imaged phased array (VIPA) etalon, to separate light in one dimension with high resolving power, as shown in FIG. 1. High-dispersion optic 120 is then cascaded with a crossed (orthogonally-oriented) low-dispersion optic 130, which may be a grating (e.g., a blazed grating) or prism, to separate overlapping spectral bins (grating orders) in the orthogonal dimension.

FIG. 1 illustrates diffraction of an optical signal has a spectrum that includes nine center wavelengths. In order of increasing wavelength, these wavelengths are λ₁₆₁, λ₁₆₂, λ₁₆₃, λ₁₇₁, λ₁₇₂, λ₁₇₃λ₁₈₁, λ₁₈₂, and λ₁₈₃. In embodiments, (i) wavelength difference (λ₁₆₃−λ₁₆₁) is less than wavelength difference (λ₁₇₁−λ₁₆₃), (ii) wavelength difference (λ₁₇₃−λ₁₇₁) is less than each of wavelength difference (λ₁₇₁−λ₁₆₃) and wavelength difference (λ₁₈₁−λ₁₇₃), and (iii) wavelength difference (λ₁₈₃−λ₁₈₁) is less than wavelength difference (λ₁₈₁−λ₁₇₃).

High-dispersion optic 120 provides fine wavelength resolution (denoted by arrows with different shades of gray) by interfering multiple consecutive bounces of a tilted Fabry-Perot etalon to create constructive interference in transmission at a wavelength-dependent angle. Spectrometers using high-dispersion optic 120 suffer from spectral overlap due to small free spectral range. Low-dispersion optic 130 provides coarse wavelength resolution (denoted by arrows with solid, dashed, and dotted lines) by scattering light to wavelength-dependent angles.

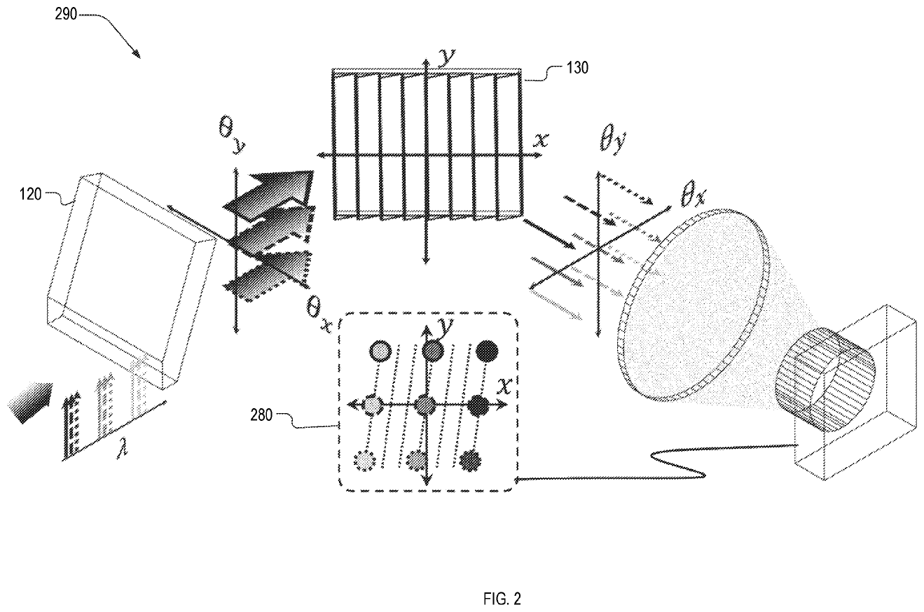

The aforementioned cascading results in a crossed-dispersion spectrometer 290, shown in FIG. 2. Spectrometer 290 includes high-dispersion optic 120 and low-dispersion optic 130 that separate the overlapping spectral orders. Spectrometer 290 creates a 2-D folded-raster pattern 280 of spectral content that maximizes the total number of measurable bins and is well suited for 2-D focusing optics and detector arrays. However, creating large time delays in free-space entails cascade of two large, dispersive bulk-optic components that are prone to misalignment and aberrations which can hinder deployment outside of ground-based observatories.

Integrated photonics provides a route toward spectrometers that are significantly smaller, lighter, and more robust than their free-space counterparts. Integrated photonic platforms enable wavelength-scale components that can drastically reduce the size and weight of optical instrumentation, while their rigid packaging increases robustness to thermal and vibrational effects.

Purely integrated dispersive spectrometers have been limited to only one dimension of on-chip dispersion, which has three primary drawbacks. First, having only one dimension of dispersion limits the maximum time delay and thus resolving power, due to inefficient use of chip area. Second, these devices typically operate at higher order which imposes a free-spectral-range (FSR) bandwidth limit. Methods for separating overlapping spectral bins and circumvent the FSR limit have added to the size and complexity of the system. Third, an integrated dispersive spectrometer with only one dimension of dispersion and no cross-disperser can only separate spectral bins in 1-D, which constrains measurements to a 1-D detector array. 1-D detector arrays typically have far fewer pixels than 2-D detector arrays, which can limit the total number of measurable spectral bins. An integrated dispersive spectrometer that can implement on-chip cross-dispersion may overcome such drawbacks and have increased resolving power and number of measurable bins in a compact and rigid system package.

Herein, we describe embodiments of a serpentine integrated grating (SIG) spectrometer, which is an integrated photonic spectrometer design that features a large delay path within a compact footprint and is the first to implement both coarse and fine axes of cross-dispersion in a single integrated device. Using an embodiment of the SIG spectrometer, we measure approximately an order of magnitude improvement in resolving power and number of measurable bins compared to other integrated photonic spectrometers. Herein, the terms SIG spectrometer and SIG device are used interchangeably.

Embodiments of the SIG device are based on a delay line that is compactly folded into a serpentine architecture, where grating couplers are directly incorporated into the delay line to dispersively couple light vertically out of the plane of the chip. The resulting architecture creates a large delay path and cross-disperses spectral content off-chip in a 2-D wavelength-beamsteered folded-raster emission pattern that is similar to that of free-space crossed-dispersion spectrometers.

An embodiment of a SIG device described herein folds a 5.2 cm long delay line into 30 sequential rows of waveguide within a 0.4 mm² on-chip footprint. The complete system only requires the addition of a high numerical-aperture (NA) lens and 2-D detector array placed directly above the chip to focus and measure the dispersed emission pattern. The absence of off-chip dispersive optics allows for a compact system, which, in this an embodiment, has dimensions of 5 cm×2 cm×2 cm.

### 2. Overview of the Serpentine Integrated Grating Spectrometer

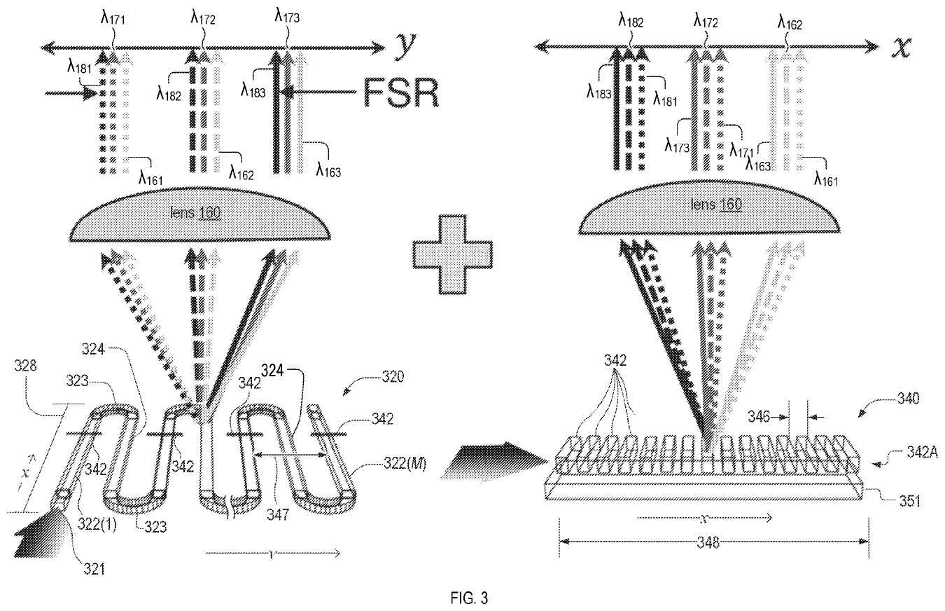

Embodiments of SIG devices disclosed herein include a folded delay line with grating couplers to disperse spectral content across a 2-D folded-raster emission pattern similar to that of crossed-dispersion spectrometer 290. FIG. 3 is a schematic of components of embodiments of a SIG spectrometer. The components include a serpentine delay line 320 a grating coupler 340, and a lens 360.

Serpentine delay line 320 includes a quantity M serially connected waveguide rows. FIG. 3 denotes orthogonal directions x and y. Herein, thicknesses of delay line 320 refer to spatial dimensions in a z direction perpendicular to the x-y plane. Each of the M rows includes a forward-propagating waveguide segment 322 oriented in the x direction, and a U-bend 323, and flyback waveguide segment 324. Along the y direction, adjacent waveguide segments 322 are spaced the y direction by pitch 347, herein also Λ_{y}. In embodiments, serpentine delay line 320 is periodic at pitch 347, where a full period of delay line 320 includes a waveguide segment 322, a flyback waveguide segment 324, and two U-bands 323. Serpentine delay line 320 also includes an input port 321, which may be perpendicular to the x-y plane.

Waveguide segments 322 may be parallel in the x direction, and each U-bend 323 may change the direction of light propagating therethrough by 180 degrees, such that light in adjacent waveguide segments 322 propagate in opposite directions. In embodiments, serpentine delay line 320 includes (i) a series of U-shaped segments, each formed by a waveguide segment 322 and waveguide segment 324 joined by a U-bend 323, and (ii) a series of U-bands 323 that connect adjacent U-shape segments and face in a direction opposite the U-bends of the U-shape segments.

Serpentine delay line 320 enables fine wavelength resolution in a dispersive spectrometer by folding a long optical delay path into a small area. This area may be less than one square millimeter. Serpentine delay line 320 has a length 328, which may be between 3 cm and 7 cm. In an embodiment, length 328 is 5.2 cm and the chip area is 0.4 mm².

FIG. 3 illustrates each waveguide segment 322 with a single diffractive element 342, which may be on or part of waveguide segment 322 thereon. Diffractive element 342 may be a protrusion or recess of a surface of waveguide segment 322, or may a disposed on waveguide segment 322. Individual diffractive elements 342 on respective waveguide sections effectively create a high-diffraction-order echelle-like structure oriented in the y direction, where the FSR is the inverse of the row-to-row delay time determined in part by pitch 347. Adjacent diffractive elements 342 are periodic in the y direction at pitch 347, such that respective single diffractive element 342 is on each waveguide segment 322.

Components of serpentine delay line 320 may have different widths in the x-y plane, which enables these components to function as either a single mode waveguide or a multimode waveguide in a specified wavelength range. This wavelength range may be from 1300 nm to 1750 nm, or from 1450 nm to 1650 nm. U-bend 323 may be a single-mode waveguide to avoid bending losses. At least one of waveguide segments 322 and 324 may have a width in the y-direction that exceeds its thickness in the z-direction, such that waveguide segment 322 can support multiple modes in the y direction and just a single mode in the z direction. Such a mode experiences less loss than a narrower waveguide because it interacts less with vertical sidewalls of waveguide segments 322 and/or 324. Hence, in the y direction, at least one of waveguide segments 322 and 324 may be wider than U-bend 323. In such embodiments, serpentine delay line 320 may include at least one of (i) an adiabatic taper between each waveguide segment 322 and each U-bends 323 and (ii) an adiabatic taper between each waveguide segment 324 and each U-bends 323. A benefit of waveguide segment 322's supporting a single mode is more uniform coupling to grating coupler 340 along the x direction.

Grating coupler 340 includes a waveguide segment 351 and a periodic array 342A of diffractive elements 342 in the x direction. Periodic array 342A has a length 348. Along the x direction, adjacent diffractive elements 342 are separated by pitch 346, herein also Λₓ, where pitch 346 is less than pitch 347 and is sub-wavelength in at least one of the aforementioned wavelength ranges. Pitch 346 may correspond to a grating frequency of between 2,000 and 3,000 line pairs per millimeter. Waveguide segment 351 is an example of waveguide segment 322. Grating coupler 340 provides the SIG device coarse wavelength resolution, and may be at least one of an integrated-photonic device, and a low-diffraction-order grating. In embodiments, each grating coupler 340 includes at least one thousand diffractive elements 342 (N>1000), and delay line 320 includes at least one ten waveguide segments 322 (M≥10), which contributes to a resolving power R=N·M. In embodiments M≥20 or M≥100, which increases resolving power.

In embodiments, each diffractive element 342 is on waveguide segments 322 and 351, as illustrated in FIG. 3. In embodiments, grating coupler 340 is a single-sidewall grating or double-sidewall grating, such that each diffractive element 342 is integrated into segment 351, e.g., as protrusions extending in the +y direction and/or the −y direction. More generally, grating coupler 340 may be, or include, at least one of sidewall grating, an overlay grating (formed of silicon nitride for example), a multi-layer grating, a unidirectional grating, an apodized width grating, a pulse-width-modulated apodized-length grating, and any combination thereof. When grating coupler 340 is unidirectional, vertical component of the propagation direction of all diffracted light has the same direction, for example, toward lens 360, where the vertical direction is perpendicular to the x-y plane.

Each of delay line 320, grating coupler 340, and diffractive elements 342 may be formed of silicon or a silicon nitride (e.g., Si₃N₄), and be disposed on an insulator substrate. Silicon has a higher refractive index than Si₃N₄, and hence enables for U-bends 323 to have a smaller radius of curvature, for a given bend-loss tolerance, than possible with Si₃N₄.

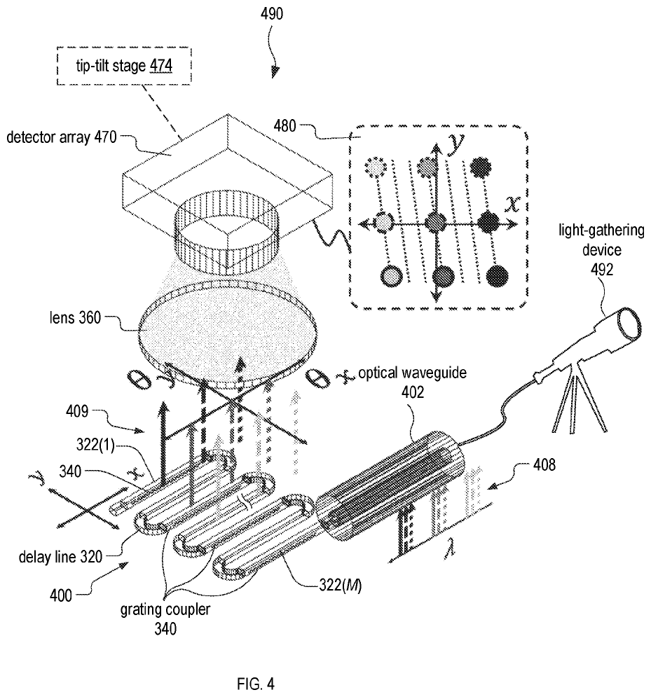

FIG. 4 is a schematic of a SIG spectrometer 490 that includes a SIG 400. SIG spectrometer 490 may also include at least one of a lens 360, and a detector array 470. Detector array 470 may by a two-dimensional detector array. SIG 400 includes a serpentine delay line 320 and grating couplers 340 on each forward-propagating waveguide segment 322. SIG 400 is in a field of view of lens 360. SIG 400 may be supported on substrate, where SIG 400 on the substrate is referred to as a SIG chip. The SIG chip may support multiple SIGs 400, and may be formed of an insulator.

Detector array 470 may be a camera, and may be located at a back focal plane of lens 360. In embodiments, detector array 470 is a silicon-based, InGaAs-based, or InAs or HgCdTe-based for operation for operation of spectrometer 490 at visible wavelengths, NIR wavelengths (1100-1700 nm), and SWIR wavelengths (1700-4000 nm), respectively.

Lens 360 may be directly above SIG 400. The optical axis of lens 360 may intersect SIG 400, either at part of delay line 320 or a region between parts of delay line 320. Lens 360 may be an integrated photonic lens, such as a Fresnel lens, formed on a same chip as SIG 400.

The entirety of each forward propagating waveguide segment 322 includes, or has thereon, a weakly-radiating grating coupler 340, such that SIG 400 includes an array of grating couplers 340 (in the y direction) that are serially connected by serpentine delay line 320. In operation, SIG 400 implements coarse/fine axes of crossed dispersion in a single integrated device.

SIG spectrometer 490 may also include an input optical waveguide 402 coupled to input port 321 of delay line 320. FIG. 4 illustrates an incident spectrum 408 fiber-coupled into SIG 400. Spectrum 408 is outputted as a 2D folded raster angular beam pattern 409 (depicted schematically in the spatial frequency domain) that mimics that of a bulk-optic crossed-dispersion spectrometer 290. Lens 360 maps angular beam pattern 409 to a 2D folded-raster tilted imaged-spot array 480 on detector array 470.

For each input frequency, the SIG 400 radiates a 2-D beam out of the x-y plane in a unique direction in the far field or position on a detector array 470 that is placed at the Fourier plane of a lens 360. The spot pattern emitted by a broadband source has tilted and folded loci that resembles the spot pattern of a free-space crossed-dispersion spectrometer, where large (coarse) frequency differences are resolved along the grating coupler dimension (x) and small (fine) frequency differences are resolved along the orthogonal row-to-row dimension (y). Lens 360 focuses angular beam pattern 409 onto detector array 470, mapping spectral content to spatial position. The original spectral intensity content may then be reconstructed from the received spatial pattern on detector array 470 by unfolding the 2-D image spectral raster and correlating with calibration data.

Embodiments of SIG spectrometer 490 have two main features that are advantageous for integrated spectroscopy. First, the resolving power is proportional to the total time delay accumulated by light propagation across the serpentine delay line 320 between the first and last grating coupler rows. This time delay may be very large because the folded delay line architecture fits a long waveguide path in a compact chip area. With this folded delay line approach that re-uses row-to-row delay, the time delay versus chip area scales better than an arrayed-waveguide grating (AWG) configuration because the folded delay line effectively uses all of the path length, whereas an AWG configuration duplicates the delay among its array of parallel waveguides. Additionally, optical propagation losses are lowered by operating in the fundamental guided mode of a wide, multi-mode waveguide. We have previously demonstrated less than 0.06 dB/cm propagation loss for 2-micrometer wide waveguides in the AIM Photonics 220-nm silicon-on-insulator (SOI) platform. Using the low-loss fundamental mode of a wide waveguide ensures the total effective delay path is not limited by optical propagation losses.

Second, embodiments of the SIG 400 directly incorporate one-dimensional grating couplers into the rows of the serpentine delay line. This architecture keeps the device footprint compact, as the time delay across one grating coupler is re-used in the next. Importantly, the grating couplers serve as the integrated equivalent to the low-dispersion diffraction gratings in a free-space crossed-dispersion spectrometer. The grating couplers separate overlapping spectral bins that would otherwise have been present if, as on the left side of FIG. 3, there was only one diffractive element 342, or power tap, per row. The combination of the small delay across each grating coupler and the large, orthogonally-oriented delay across the full extent of the serpentine delay line results in a crossed-dispersion effect that both increases the number of measurable bins and radiates a 2-D emission pattern that is well suited for focusing optics and 2-D detector arrays.

Serpentine delay line 320 is orientated in a delay-line plane, denoted as the x-y plane in FIG. 4. Lens 360 is between detector array 470 and serpentine delay line 320. Each of the plurality of grating couplers 340 directs light propagating in serpentine delay line 320 toward lens 360. Grating couplers 340 are (i) located at respective locations along the serpentine delay line 320 and (ii) are serially connected by serpentine delay line 320. In an example mode of operation: grating couplers 340 are sequentially illuminated by light propagating in the serpentine delay line; each grating coupler 340 direct lights propagating in the serpentine delay line out of a plane of the serpentine delay line toward lens 360; and lens 360 receives a folded spectrum emitted by grating couplers 340 as a two-dimensional spatial pattern from which a one-dimensional spectrum may be recovered.

In embodiments, SIG 400 may be formed via a technology other than integrated photonics, which enables operation in wavelength bands where silicon is not transparent. For example, at least one of delay line 320 and grating coupler 340 may be formed of glass or indium phosphide.

In embodiments, e.g., when SIG spectrometer 490 is used at visible wavelengths, serpentine delay line 320 is formed of Si₃N₄ or glass, and detector array 470 includes silicon-based CMOS sensors or CCDs. In embodiments, when SIG spectrometer 490 is used at near infrared or short wave IR wavelengths, serpentine delay line 320 is formed of Si₃N₄ or silicon, and detector array 470 includes InGaAs sensors or InSb sensors.

SIG spectrometer 490 is shown in an example use scenario, in which an optical output port of a light-gathering device 492 is coupled to SIGs 400 via optical waveguide 402. While FIG. 4 illustrates light-gathering device 492 as a telescope, this is merely one example of light-gathering device 492. Additional examples of light-gathering devices 492 include imaging optics (e.g., lenses, imaging systems, microscopes, camera lenses) as well as non-imaging optics (e.g., light concentrators, solar concentrators, prisms, and axicons). Examples of optical waveguide 402 include an optical fiber, and an integrated photonic waveguide, such as a silicon-on-insulator waveguide.

In embodiments, light-gathering device 492 and at least one of delay line 320 and SIG spectrometer 490 are on a common substrate and/or printed circuit board. For example, light-gathering device 492 and SIG spectrometer 490 may be part of a common photonic integrate circuit. In embodiments, at least one of SIG spectrometer 490 and light-gathering device 492 are incorporated into a mobile device, examples of which include a mobile computer, a tablet computer, a mobile phone, and a smartwatch.

### 3. SIG Spectrometer Operation, Resolving Power and Bandwidth

In this section, we quantify the operation, resolving power and bandwidth of an embodiment of SIG spectrometer 490, and relate those metrics to an example design geometry. The SIG emits beams of monochromatic light out of the plane of the chip to angles uniquely determined by their respective optical frequencies. The frequency shift between two minimally spatially resolved beams determines the frequency resolution of the SIG spectrometer. As with any spectral measurement, this spectral resolution is inversely proportional to the delay accumulated as light propagates through the entire aperture.

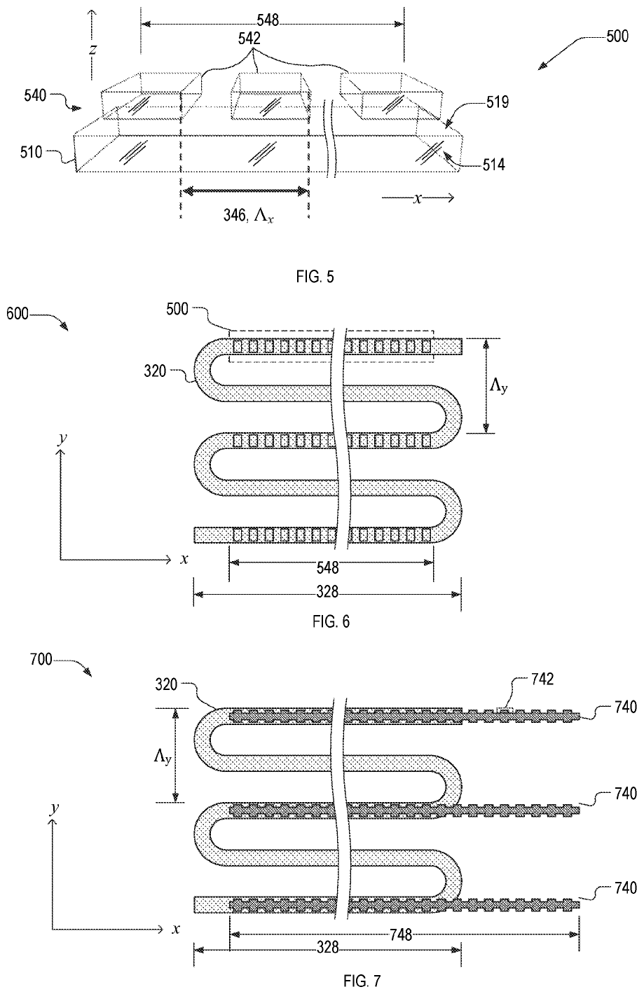

FIG. 5 is a schematic of a grating coupler 500, of which grating coupler 340 is an example. Grating coupler 500 is an integrated 1-D diffraction grating that includes a waveguide 510 with the addition of a periodic array 540 of diffractive elements 542, N in number, separated by pitch 346, hereinafter also Λₓ. Each diffractive element 542 is an example of a diffractive element 342. Waveguide 510 has a top surface 519 and a front side-surface 514, and a rear side-surface, not shown in FIG. 5. Each of side-surfaces is parallel to the x-z plane. Waveguide 510 is an example of waveguide segment 322.

In embodiments, grating coupler 500 is an overlay grating, such that each diffractive element 542 is on a top surface 519 of waveguide 510. Each diffractive element 542 may be formed of silicon nitride or silicon. Diffractive elements 542 may be directly on top surface 519, or be on one or more layers located between top surface 519 and diffractive elements 542. For example, to achieve desired coupling out of grating coupler 500, grating coupler 500 may include an oxide layer between diffractive elements 542 and top surface 519.

In other embodiments, grating coupler 500 is a single-sidewall or double-sidewall grating-waveguide, such that each diffractive element 542 is a protrusion from front side-surface 514 and/or the rear side-surface of waveguide 510. In such embodiments, grating coupler 500 is integrated into waveguide 510.

Grating coupler 500 has a length 548 in the x direction, which equals RAN, and is an example of length 348. The periodic radiating perturbations sample the guided mode's wavelength-dependent propagation phase and diffract each wavelength to a beam with a unique angle out of the plane of the chip in the plane that includes the direction of mode propagation in waveguide 510. In embodiments grating coupler 500 is a high-dispersion grating that operates at the lowest diffraction order, and operates analogously to free-space gratings where the skimming angle of incidence is 90° from normal. Grating coupler 500 By itself, grating coupler 500 may be used as a 1-D spectrometer, where its spectral resolution Δω is inversely proportional to the group delay time for light to travel across the entire length of the grating coupler. Given pitch Λₓ and length L=NΛₓ of grating coupler 500, its resolving power is

$$R = \frac{{ω}_{0}}{Δω} = \frac{L}{{Λ}_{x}}$$

which is equal to the number of grating periods N.

FIG. 6 is schematic of a SIG 600, which includes a periodic array of M parallel rows of grating couplers 500 that are serially connected by serpentine delay line 320. In an analogous manner to the 1-D grating coupler, SIG 600 emits beams of light to wavelength-dependent directions. However, the beam direction is two dimensional rather than one, where the spatial phase factor

$${k}_{x} = β ( ω ) - \frac{2 π}{{Λ}_{x}}$$

determines the angle in the direction of grating coupler propagation (β is the fundamental guided mode's propagation constant), and the row-to-row phase Δϕ_{y} determines the angle in the orthogonal in-plane direction as

$${k}_{y} = \frac{{Δϕ}_{y}}{{Λ}_{y}} .$$

Two useful quantities we define are: (i) τₓ, the group delay time across one grating coupler 500, and (ii) τ_{y}, the group delay time across all M rows of delay line 320, between grating coupler 500(1) and grating coupler 500(M). Since delay accumulates in both the x- and y-dimensions, the loci of broadband emitted beams create a tilted pattern (known as a folded raster) similar to that of spectrometers 290 and 490.

Here we define a factor F≡(τ_{y}/M)/τₓ, which is the ratio of the row-to-row delay time to the delay across a single grating coupler 500. Equivalently, factor F is the ratio of the frequency separation between Rayleigh resolved beams along the x-dimension to the FSR of the y-dimension:

$$F ≡ ( {τ}_{y} / M ) / {τ}_{x} = \frac{{Δω}_{x}}{2 π} / FSR . When {τ}_{y} ≫ {τ}_{x} ,$$

small (fine) frequency differences are resolved along the y-dimension while large (coarse) frequency differences are resolved along the x-dimension.

The diffraction-limited spectral resolution of SIG 600 is inversely proportional to τ_{y}, since τ_{y} is the largest time delay across the full extent of the array of grating couplers. The spectral resolution may be derived from the frequency shift between two Rayleigh resolved beams in the y-dimension. The emission angle along y, θ_{y}, is given by the relative phase Δϕ_{y}(ω) and pitch Λ_{y} between adjacent rows:

$${θ}_{y} = {sin}^{- 1} ( \frac{{Δϕ}_{y} ( ω ) + 2 π q}{{k}_{0} ( ω ) {Λ}_{y}} ) , \qquad ( 1 )$$

where

$$q = \frac{{τ}_{y} / M}{2 π / ω}$$

is an integer representing the very large frequency-dependent diffraction order and

$${k}_{0} = \frac{ω}{c}$$

is the free-space wavenumber. Assuming each complete row of serpentine delay line 320 has length ΔL=FL and is approximately geometrically invariant, then Δϕ_{y}(ω)=β(ω)ΔL. The spectral resolution in the y-direction, Δω_{y}, corresponds to the angular frequency difference which produces a 2π phase difference across the M grating rows along the entire y dimension of the aperture:

$$\frac{d {Δϕ}_{y}}{d ω} \cdot M \cdot {Δω}_{y} = 2 π . \qquad ( 2 )$$

The phase delay is

$$\frac{d {Δϕ}_{y}}{d ω} = \frac{{n}_{g} ( ω ) Δ L}{c} , where {n}_{g} ( ω ) = c \frac{d β ( ω )}{d ω}$$

is the waveguide mode's group index, giving the spectral resolution along the y-dimension as:

$${Δω}_{y} = \frac{2 π}{M} \frac{c}{{n}_{g} Δ L} = \frac{2 π}{{τ}_{y}} . \qquad ( 3 )$$

Equation (3) shows that the spectral resolution in the y-dimension, Δω_{y}, is inversely proportional to the total group delay time from the first to last row of serpentine delay line 320, τ_{y}. Δω_{y} is the diffraction-limited angular spectral resolution of the SIG spectrometer.

Factor F determines the amount of angular separation between coarse frequency bins in the x-dimension. At F=1, coarse frequency bins that are one fine-dimension FSR apart are spatially separated by exactly one Rayleigh-resolved beam width. When F>1 the angular separation between coarse frequency bins decreases, and when F<1 the angular separation increases.

In embodiments, SIGs disclosed herein, such SIG 400 and SIG 600, has F≡(τ_{y}/M)/τₓ<1, so that the emission pattern is well-separated along the x-dimension between coarse resolution bins separated by one fine-dimension FSR, to minimize beam sidelobe crosstalk. This corresponds to setting the time delay across a single grating coupler to be longer than the time delay between rows. In embodiments, factor F is less than 0.5. In combination with apodization across the rows (such that each grating coupler 500 is apodized) such that each row emits a beam with a smooth profile (such as a Gaussian), a value of factor F less than 0.5 is often sufficient for decreasing this crosstalk to favorably low amounts. Factor F may be less than 0.3 for further reducing crosstalk. In embodiments, factor F is satisfied at free-space wavelength ranges, such as between 1300 nm and 1750 nm, or within that range, between 1450 nm and 1650 nm.

Factor F may be expressed as a relationship between the respective lengths and mode indices of grating coupler 340 and serpentine delay line 320. Time delay τ_{y} is the product of a geometric length L₃₂₀ of delay line 320 and its group refractive index n_{g320} at a wavelength λ₀ of a propagating mode. Geometric length L₃₂₀ is the product of the length of one s-shaped row, ΔL=FL and the number of rows M, such that time delay τ_{y}=Δ Ln_{g}M. Time delay τₓ is the product of a length 348 (herein also L₃₄₈) of periodic array 342A and its group refractive index n_{g340} at wavelength λ₀: τₓ=L₃₄₈n_{g340}. Accordingly, factor F may be expressed as: (L₃₂₀n_{g320}/M)/(L₃₄₈n_{g340}).

In SIG 600, length 548 of grating coupler 500 is limited by, and less than, length 328 of serpentine delay line 320, and hence places a lower limit on factor F, which may result in excessive crosstalk between coarse resolution bins. Length 548 is an example of length 348. However, as discussed in Sec. 5C, a multi-level SIG 700 shown in FIG. 7 decouples length 328 of delay line 320 from the length of the grating couplers to achieve more favorable delay ratios. SIG 700 is an example of SIG 400. Multi-level SIG 700 includes a plurality of grating couplers 740, each of which is directly above a respective one of waveguide segments 322 of delay line 320. Each grating coupler 740 is an example grating coupler 340, and has a grating length 748, which is an example of length 348 and is greater than or equal to length 328. In embodiments, length 748 is more than twice length 328, and may exceed length 328 by at least a factor of four. In embodiments, a ratio of length 478 to length 328 is between two and five. Grating coupler has a plurality of periodic protrusions 742, each of which is an example of a diffractive element 342. Without departing from the scope hereof, grating coupler 740 may be a different type of diffraction grating (other than double sidewall), such as those mentioned in the description of grating coupler 340, while still having length 748.

The operational bandwidth of SIG spectrometer 490 is determined by the angular dispersion of SIG 400, the NA of lens 360, and the size of detector array 470. When SIG 400 operates over a 1300-1750 nm range and for specific spectrometer architectures, the lens' NA=n_{bulk} sin(θ_{FOV}/2) limits the field of view (FOB) and thus the operational bandwidth. The limiting scanning dimension is the angular range θ_{FOV} captured by the lens along the x-(low-dispersion) dimension. Assuming that the angular field of view, θ_{FOV}, is centered at normal emission where

$$β ( {ω}_{0} ) = \frac{2 π}{{Λ}_{x}} ,$$

the phase matching relationship gives us the propagation constants β(ωₘᵢₙ) and β(ωₘₐₓ) at the bandwidth's minimum and maximum frequencies ωₘᵢₙ and ωₘₐₓ:

$$β ( {ω}_{min} ) = \frac{- {ω}_{min}}{c} {n}_{bulk} sin ( \frac{{θ}_{FOV}}{2} ) + \frac{2 π}{{Λ}_{x}} \qquad ( 4 )$$

$$β ( {ω}_{max} ) = \frac{{ω}_{max}}{c} {n}_{bulk} sin ( \frac{{θ}_{FOV}}{2} ) + \frac{2 π}{{Λ}_{x}} , \qquad ( 5 )$$

where n_{bulk} is the refractive index of the bulk material between the chip and the detector. Taking the difference in β and dividing by the bandwidth results in the following relationship:

$${\frac{β ( {ω}_{max} ) - β ( {ω}_{min} )}{{ω}_{max} - {ω}_{min}} \approx \frac{d β}{d ω} \vert}_{ω = {ω}_{0}} = \frac{{n}_{g} ( {ω}_{0} )}{c} = \frac{{n}_{bulk}}{c} sin ( \frac{{θ}_{FOV}}{2} ) . \qquad ( 6 )$$

Thus θ_{FOV} is dependent on n_{g}(ω₀) and n_{bulk}:

$${θ}_{FOV} = 2 {sin}^{- 1} ( \frac{{ω}_{op}}{2 {ω}_{0}} \frac{{n}_{g} ( {ω}_{0} )}{{n}_{bulk}} ) . \qquad ( 7 )$$

Eq. 7 shows that reducing the waveguide mode's group index and/or using a higher index bulk material will increase the SIG spectrometer's bandwidth. This corresponds to decreasing the angular dispersion in order to fit a larger frequency bandwidth into the same angular range.

### 4. Experimental Demonstration

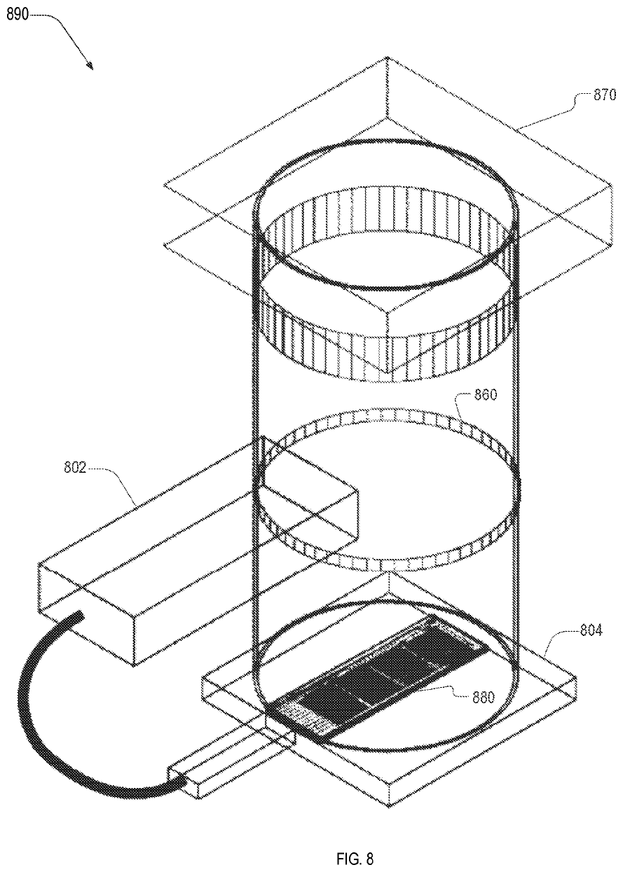

FIG. 8 is a schematic of a SIG spectrometer 890, which is an example of SIG spectrometer 490. To calibrate and demonstrate SIG spectrometer 890, we use an apparatus depicted in FIG. 8. SIG spectrometer 890 includes multiple SIGs 800, a lens 860, and a detector array 870 which are respective examples of SIG 400, lens 360, and detector array 470. Detector array 870 may be a 640×512 pixel InGaS detector array, for operation in the NIR for example. SIG spectrometer 890 also includes a SIG chip 880, supports a twelve SIGs 800, and was fabricated in the AIM Photonics SOI process, which uses a 220-nm thick silicon device layer.

The apparatus includes a continuously tunable narrow linewidth laser 802 and a thermoelectric cooler 804. Lens 860 is achromatic, has a 2-cm diameter, a 0.45 NA, a 23-mm focal length and is located approximately 1 cm above SIG chip 880.

Laser 802 is edge-coupled to SIG chip 880 using 10.5 micrometer mode-field-diameter (MFD) polarization-maintaining (PM) single-mode fibers (PANDA PM15-U25D). The laser power is set to 1 milliwatts and stabilized to within ±10 microwatts across the measurement bandwidth. For spectral resolution measurements, a second laser is multiplexed with the emission of laser 802 using a 50/50 PM fiber splitter (not pictured). SIG chip 880 is placed on thermoelectric cooler 804 and held at a constant 22.5° C. to avoid phase drifts that could degrade the calibration. The emission is captured by a lens 860. Detector array 870 is located in the back focal plane of lens 860 to image the angular emission pattern of SIG chip 880.

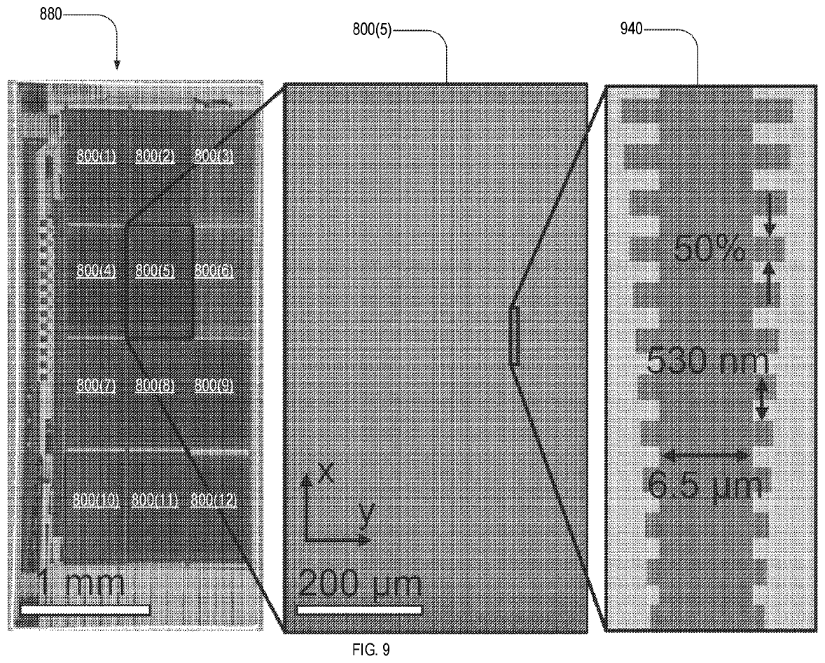

FIG. 9 includes an images of SIG chip 880. SIG chip 880 includes twelve SIGs 800(1, 2, . . . , 12). FIG. 9 also includes a schematic of an apodized sidewall grating 940 used in SIG 800(5). Each SIG 800 has a footprint of 0.47×0.86 mm². Each SIG 800 is connected to a tapered edge-coupler device (provided by the AIM process development kit, insertion loss <3 dB) for coupling from a single mode integrated waveguide to a 10-micrometer MFD polarization-maintaining single-mode fiber aligned to launch a TE mode.

SIG 800 includes thirty grating-waveguide rows spaced by a 16-micrometer pitch, interspersed with twenty-nine flyback waveguides and connected by adiabatic bends and tapers, for a total delay line length of 5.2 cm. Each of the grating-waveguide rows is an example of waveguide segment 322. Each of the flyback waveguides is an example of a flyback waveguide segment 324. The 16-micrometer row-to-row pitch, an example of pitch 347, creates grating lobes along the y-dimension with an angular period of 5.5°. Both grating 940 and flyback waveguides are 6.5 micrometers wide and 690 micrometers long, where they operate in the fundamental transverse-electric (TE0) mode (2.84 effective index at 1.55 micrometer wavelength) of these multi-mode waveguides to minimize propagation losses. The U-bends at the ends of each row (examples of U-bends 323) are 500 nm wide (single mode width) and have linearly changing curvature to reduce mode mismatch losses at the start and ends of the bends.

In embodiments, the row-to-row pitch is 5.5 micrometers, where the grating 940 is three-micrometers wide and the flyback waveguide segments are 1.5 micrometers wide, and gaps therebetween are 0.5 micrometers wide. The gaps may be filled with a low-index material, such as silicon dioxide.

Quadratically-shaped tapers (length: 80 micrometers) are used to transition from the 500 nm-wide bends to the 6.5-micrometer wide grating and flyback waveguides. The taper length may be less than 80 micrometers without departing from the scope hereof. The gradual tapers and single-mode bends help prevent the excitation of higher order waveguide modes. We have measured less than 0.06 dB/cm loss in the fundamental mode of the wide waveguides. The wide waveguide's low propagation loss is crucial as it enables a long delay path and correspondingly high spectral resolution. Using a simulated group index of 3.58 for the TE0 mode of the wide multi-mode waveguide, the theoretical diffraction limited spectral resolution is 1.6 GHz.

The low propagation loss also suggests that very little guided field interacts with the waveguide sidewalls, which helps suppress the excitation of higher-order waveguide modes from surface roughness and/or fabrication defects. The losses of the other components are 0.07 dB per taper and 0.003 dB per bend for an estimated 9 dB total propagation loss (8.4 dB of which is from taper losses) across the demonstrated SIG design.

As illustrated in FIG. 9, grating 940 may be a double-sidewall grating-waveguide with a constant 540-nm grating period and 50% duty cycle [FIG. 9, right]. This period was chosen such that incident light in the TE0 mode of the grating-waveguide is emitted vertically at approximately 1500 nm wavelength. Each grating coupler of the array of grating couplers is apodized by exponentially increasing the depth of the grating teeth both along and across rows between 73 nm and 500 nm to have approximately uniform emission across the entire aperture. In embodiments, other types of apodization profiles, such as a Gaussian emission apodization across each grating coupler row for the two-level SIG design with F<1 shown in FIG. 7, may be used to lower the sidelobes in the emission profile and decrease crosstalk between adjacent coarse resolution beams that are separated by the fine dimension's FSR.

To achieve its full spectral resolution and precision, SIG spectrometer 890 is calibrated before taking measurements. When calibrating, laser 802 steps in frequency, where at each frequency the response of 2-D detector array 870 is recorded to be used for mapping a detected image to its corresponding input spectrum.

In embodiments, serpentine delay line 320 is formed of silicon, row-to-row pitch 347 is 5.5 microns, forward-propagating waveguide segment 322 is a 3-micron wide low-loss multimode waveguide grating, each flyback waveguide segments 324 is a 1.5-micron few mode waveguide. Such embodiments may include, between adjacent segments 322 and 324, 0.5-micron gaps embedded with SiO₂. Grating coupler 340 includes Si₃N₄ periodic grating bars. In embodiments, flyback waveguide segments 324 may support fewer modes than forward-propagating waveguide segments 322.

Any one of forward-propagating waveguide segments 322, U-bends 323, and flyback waveguide segments 324 may be made out of any high-index material embedded in a low-index cladding. Examples include silicon or silicon nitride embedded in glass, or a III-V semiconductor such as In or GaAs embedded in air. Pitch 346 of grating coupler 340 that results in diffracted light radiating normally to the integrated photonic device surface is determined by the index of the lowest order fundamental mode of the waveguide grating, nₘ (typically between 1.6 and 4.5), giving a spacing Λ=λ₀/nₘ, which will be a fraction of the free space wavelength.

This normal emission wavelength may be a midband frequency for a wideband spectrometer, but the 2^{nd}-order grating coupling to the backwards mode at this exact wavelength could affect the efficiency, so operation over just the backwards angles

only at longer wavelengths may be warranted.

Pitch 347 of the row-to-row spacing will be limited by the bend radius of curvature that can achieve sufficiently low loss (e.g., 0.003 dB achieved, 0.001 dB expected) to allow scores to hundreds of rows and the multimode waveguide width with sufficiently low fundamental mode propagation loss (0.06 dB/cm achieved). In embodiments, pitch 247 is between one micrometer and one-hundred micrometers, which ensures low loss.

Such low loss enables an accumulated time delay approaching a nanosecond in order to achieve GHz-scale spectral resolution with 7.9-cm waveguide path length folded up in 96 serpentine rows of about 400-micron length with Si group index n_{g}^{Si}=3.8 fits in a 410×528 micron footprint. To achieve sufficiently low loss to fold up substantial delay in the serpentine either very low loss technologies like high-index doped glass optical waveguides or the small fundamental mode of a transversely multimode waveguide may be used, with waveguide widths from just over a micron to ten microns, and low-index gaps from just under a micron to a few microns.

The time delay τₓ of the waveguide grating rows emerging from each row of the serpentine delay line should be at least three to five times longer than the row-to-row serpentine delay (τ_{y}/M) in order to separate the successively scanned spectral orders of the falling raster folded spectrum by several spot widths to avoid any crosstalk.

When using a Si multimode waveguide serpentine delay line in the NIR (n_{g}^{Si}=3.8) and a Si₃N₄ multimode waveguide grating (n_{g}^{SiN}=2.1) then assuming small taper and bend time delay, the waveguide grating length will need to be L_{g}>α2Lᵣn_{g}^{{Si}}/n_{g}^{SiN} with Lᵣ the length of the serpentine rows (e.g., length 328) and L_{g} the length of the waveguide grating couplers (e.g., length 748). Coefficient α is between three and five. For the example above, that leads to a Si₃N₄ waveguide grating row length of between 4.5-7.5 mm and height of 0.528 mm for this extreme example of a 1-GHz resolution SIG with 96 rows.

More rows with less time delay may be used to fold this SIG into a more square aperture, for example in a total height of 1.4 mm using 256 serpentine rows of length 150 microns with waveguide grating rows of length 1.6-2.8 mm will have a shape with an aspect ratio closer to one. Such a 1.4×1.6 mm SIG device with Si₃N₄ waveguide gratings could be stacked into a 6×7 array for multimode spectral analysis of a multimode fiber photonic lantern with 21 dual-polarization single-modes all in a 1 cm² chip area, which could cover a bandwidth of 1200 nm to 1700 nm using a lens with NA of about 0.5.

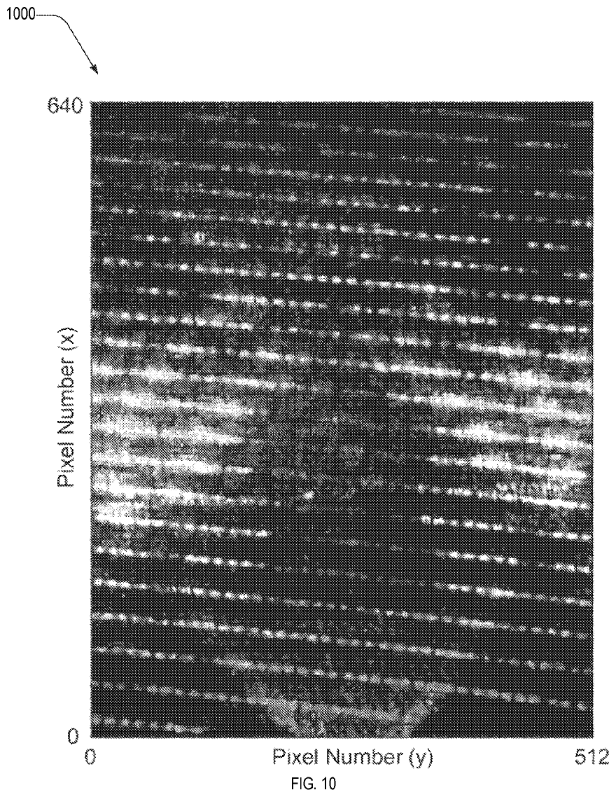

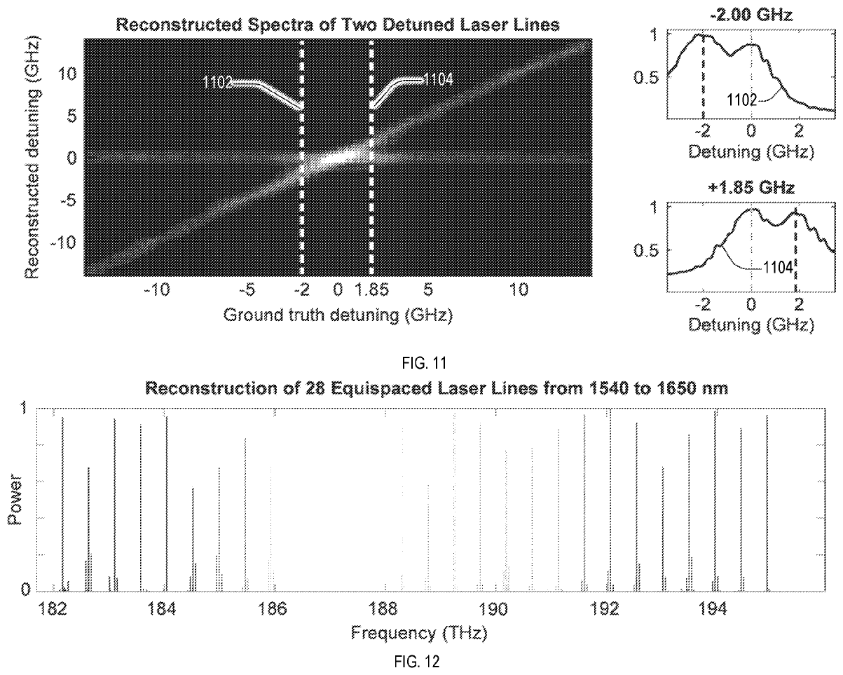

FIG. 10 shows an example composite image 1000 of calibration data. Composite image 1000 is of multiple calibration wavelengths (only 285 lines out of the total ˜6750 resolvable spectral bins). The spot size of a single wavelength on the detector is approximately 5×9 detector pixels large. Two calibration datasets were taken. First, we stepped the tunable laser in 50-MHz increments across a 100 GHz bandwidth. The resulting calibration data was used to precisely determine the spectrometer resolution by reconstructing two laser lines as one laser scans across the other in frequency, as shown in FIG. 11.

FIG. 11 shows reconstructed spectra using inner product with 50 MHz stepped calibration data of two nearby laser lines (at ground-truth detunings 1102 and 1104) as one laser scans ±15 GHz across the second reference laser (at 191.43885 THz frequency) in 50 MHz increments. The two lines are Rayleigh resolved (dip between peaks is 1 dB below reference laser's peak) at −2.00 GHz and +1.85 GHz ground truth laser detunings.

Second, we stepped the tunable laser in 1-GHz increments across the entire operational 13 THz frequency range (from 1540 nm to 1650 nm). This calibration data was used to reconstruct 28 nominally equispaced frequency lines across the 13 THz frequency range, for the purpose of showing the full bandwidth capability of this system, as shown in FIG. 12. FIG. 12 is a power spectrum showing spectral reconstruction using a non-negative least squares algorithm with 1-GHz stepped calibration data of 28 equal power and equispaced single-frequency inputs demonstrating a 1540 nm (194.8 THz) to 1650 nm (181.8 THz) spectrometer bandwidth. This calibration data was also downsized from 640×512 pixels to 640×200 pixels to cover only the main grating lobe.

To demonstrate the resolution of SIG spectrometer 890, we generated a test image set of two multiplexed lasers (laser 802 and the aforementioned second laser), where the frequency of one laser is scanned with respect to the other. The second laser was used as the reference and was held at a constant 191.43885 THz frequency (1566.0 nm wavelength), while laser 802 scanned ±15 GHz around the second laser in 50 MHz increments. For each test image, the spectral content is reconstructed by taking the inner product of the test image with each of the 50 MHz stepped calibration images. To perform this operation, the 2-D calibration images are vectorized and concatenated into a calibration matrix M̅ where each column represents a vectorized calibration image. Each calibration image is also normalized to compensate for static wavelength-dependent losses in the system. The spectral content is then simply reconstructed by performing \vec{x}=M̅^{T}\vec{y}, where \vec{y} is the vectorized test image, and x is the reconstructed spectra. The results of selected test image reconstructions are shown in FIG. 11. In particular, the two laser frequencies are Rayleigh resolved (defined as the frequency separation where the dip between the two peaks is 1 dB below the peak of the reference laser) at −2.00 GHz and +1.85 GHz detuning, resulting in an average resolution of 1.93±0.07 GHz or resolving power R of 99200±3600 at 1566 nm wavelength.

To demonstrate this spectrometer's operational bandwidth, we input and reconstruct twenty single frequencies of equal intensity that are nominally equally spaced across the entire 1540-1650 nm bandwidth and chosen at random frequencies in between calibration frequencies. For this reconstruction, we chose to use a non-negative least squares (NNLS) algorithm which minimizes ∥M̅\vec{x}−\vec{y}∥ under the constraint that \vec{x}≥0 and is useful for lowering spectral sidelobes caused by cross-talk between bins. The resulting reconstruction is shown in FIG. 12. Notably, the calibration and test data were taken one day apart, showing temporal stability of our system. The ˜3 dB variation of measured power within the 120-nm bandwidth that is visible in FIG. 12 is a result of the frequency offset between the test and calibration points.

In the worst case, the test frequency sits precisely between two calibration frequencies (at a half GHz), and the reconstructed power is evenly split between the two adjacent calibration frequencies. Simple binning (summing) of the energy in adjacent pixel pairs improves the amplitude accuracy to well over 90% (not shown here). The 120-nm bandwidth demonstrated here is limited by the NA of lens 860. SIG 800 can operate at wavelengths ranging from below 1300 nm to beyond 1700 nm, but the angular range of the emission pattern would be impractically large along the coarse axis with this particular silicon waveguide design.

As seen in FIG. 11, the reconstructed spectrum contains spectral artifacts around the main spectral peaks that are spaced ˜46-47 GHz apart. The spectral artifacts averaged a value of −10 dB, with a maximum of −6.9 dB. The spectral spacing of these artifacts is the fine-dimension FSR, which indicates that they are caused by the partial x-dimensional spatial overlap of adjacent coarse frequency resolution bins on the detector. This is a non-ideality of the F≈2.4 SIG device that we used. A refined SIG design that greatly reduces coarse dimension crosstalk by having longer grating coupler time delay than row-to-row time delay (F<1), along with apodization along the rows, is described in Sec. 5.C.

### 5. Discussion

SIG spectrometer 890 has a 1.93±0.07 GHz spectral resolution and ˜6750 measurable bins over a 120 nm bandwidth in a 0.4 mm² footprint. To place these results in context, the demonstrated SIG spectrometer can be compared to different integrated photonic spectrometer technologies as reviewed in reference [1], which shows that the SIG spectrometer has approximately an order of magnitude higher resolving power and number of spectral bins than any other wide bandwidth integrated photonic spectrometers. This is due to the much higher ratio of resolution (time delay) to footprint as compared to other integrated photonic dispersive spectrometer technologies such as AWGs and planar echelle gratings. The integration of the grating couplers into the folded delay line itself, and reuse of the delay from row-to-row of these grating couplers allows the device to use the total serpentine delay line length to contribute to the spectral resolution.

In the remainder of this section, we discuss various embodiments of SIG spectrometer 490, FIG. 4. First, both the insertion loss and fluctuations in efficiency may be decreased. In embodiments, SIG 400 has independently patterned and layers that form a dual-level SIG architecture, where delay line 320 is formed of a first material, such as silicon, and each diffractive element 342 is formed of a second material. The second material may be the same as the first material, or may differ from the first material. For example, the first material may be silicon, and the second material may be Si₃N₄

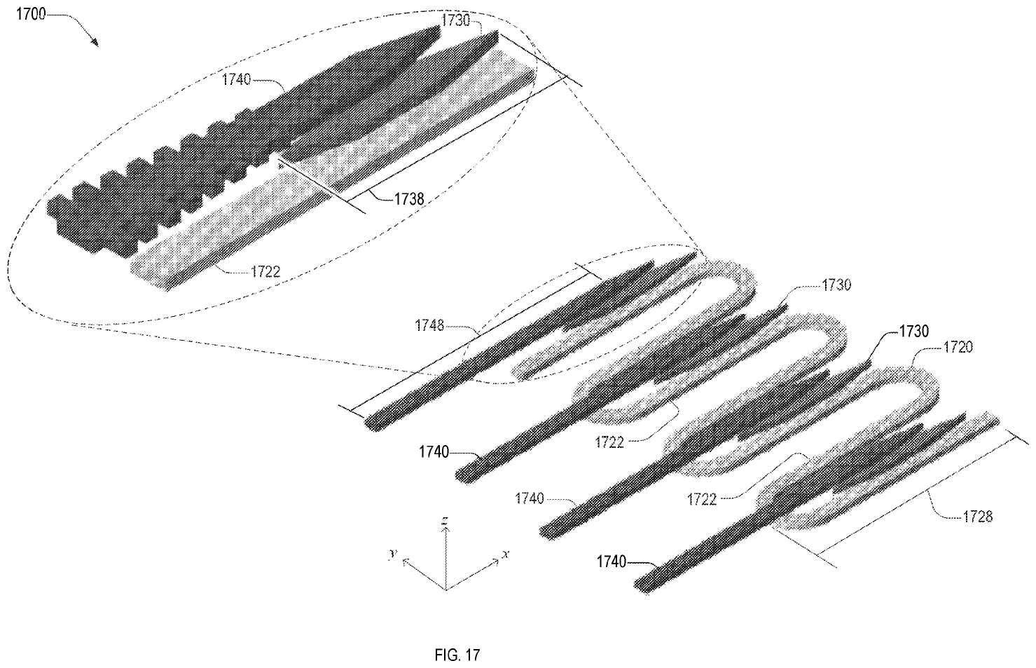

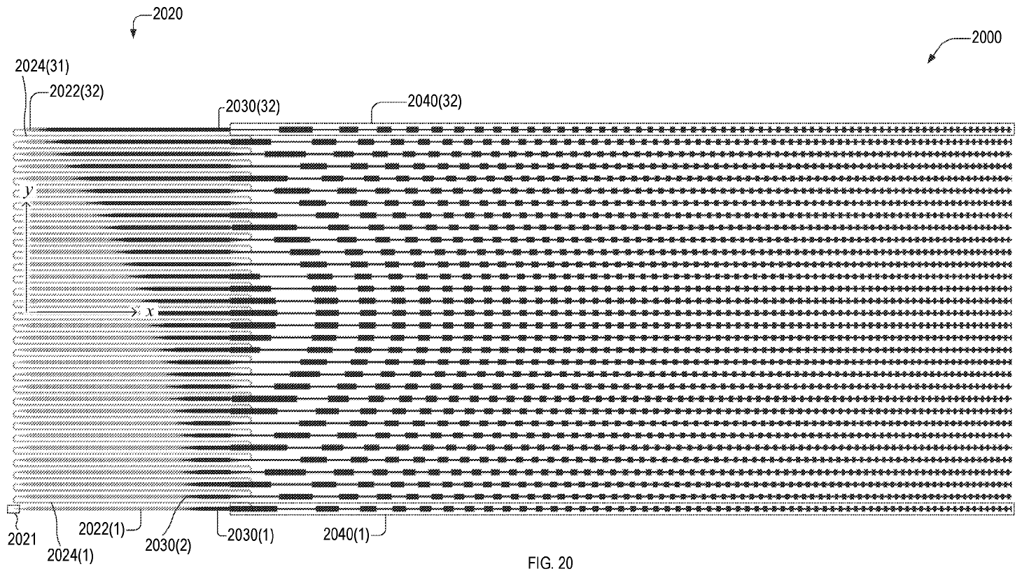

This dual-level SIG architecture separates serpentine delay line 320 from grating couplers 340 with evanescent taps from the delay-line layer up to the grating-coupler layers, as shown in FIG. 7 above, and FIGS. 17 and 20 described below. Using multi-level grating designs that radiate light unidirectionally may also improve the grating efficiency by an additional 3 dB.

The current limitation on SIG spectrometer 490's bandwidth is the angular FOV captured by lens 360. Increasing the group velocity of modes guided by the waveguide-grating (formed by a waveguide segment 322 and a grating couplers 340) which increases the bandwidth captured by the lens' FOV. In embodiments, SIG 400 is fabricated using a lower refractive-index-contrast platform such as silicon-nitride-on-insulator. That is, at least part of serpentine delay line 320 (e.g., one or both of waveguide segment 322 and grating coupler 340) may be formed of silicon-nitride and be disposed on an insulator substrate, such as a silicon dioxide substrate.

A lens-less design that uses a focusing SIG can also improve the bandwidth by emitting into a high index glass prism, as discussed in Sec. 5B. To address an even larger range of wavelengths, one can design multiple SIGs where each targets a different wavelength band of interest by choosing the waveguide material, grating period and waveguide cross-section, in combination with the appropriate detector array technology.

To improve spectral resolution, one can increase the serpentine delay line length. The total possible delay line length is dependent on the waveguide propagation loss and the bend and taper insertion losses. When the waveguide propagation loss is 0.06 dB/cm, as described herein, and assuming an optimistic scenario where the bend and taper losses can be neglected, embodiments of serpentine delay line 320 may be formed of silicon and be as long as 16.7 cm for an insertion loss of 1 dB.

As of filing the present application, the largest SOPA-based SIG design which we have designed and fabricated thus far has 96 rows, 1.8 mm long row lengths, and factor F is approximately 2.1, resulting in a total delay line length of approximately 36.3 cm while occupying a footprint of 0.765×1.881 mm².

Beyond these extensions, more advanced refinements and modified architectures of the SIG spectrometer which further improve performance are discussed in Sec. 5A-5C. We additionally note that the concept of adding grating couplers to an integrated dispersive spectrometer may be extended to other existing technologies as well. For example, grating couplers of the appropriate length for separating FSRs can be appended to an AWG, which would increase the total number of measurable bins and could be a useful modification for existing integrated dispersive spectrometers. The resolving power would still be limited by the total delay of the chosen dispersive spectrometer technology, of which the SIG spectrometer's folded serpentine delay line has a definite advantage.

### 5A. High-Etendue Tiled SIG Array

In many remote sensing measurements, light passes through atmospheric turbulence, which creates time-varying movements and phase distortions on the wavefront. Such movements and distortions may also occur when the measured sample has a rough surface. A telescope can efficiently receive a distorted wavefront and couple it into a multi-mode-fiber (MMF), where the MMF will pick up significant amounts of power in all of its supported fiber modes. However, a single SIG device requires a polarization-maintaining single-mode fiber (PMF) input, which would have substantial etendue insertion loss and temporal variation if coupled to a MMF input. To recover this loss, it has been demonstrated that a photonic lantern can be used to couple light from a MMF to an array of single-mode fibers (SMFs) that then feeds an integrated spectrometer such as an AWG.

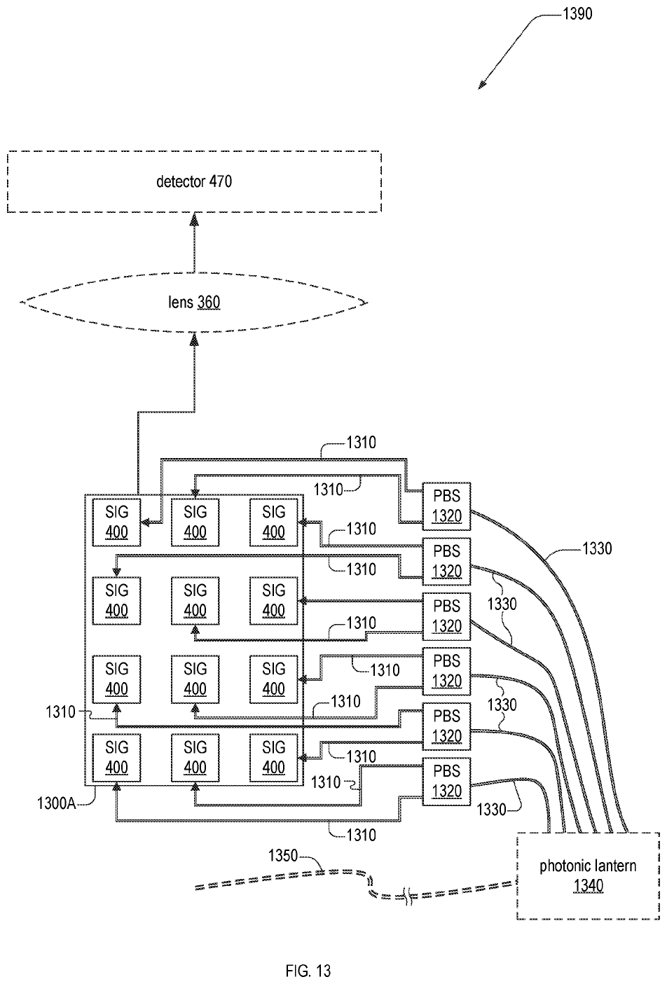

FIG. 13 is a schematic of a SIG spectrometer 1390. SIG spectrometer 1390 is an example of SIG spectrometer 490, and includes a plurality of SIGs 400 that form SIG array 1300A. Each SIG 400 of SIG array 1300A may be oriented in the same direction, such that each all waveguide segments 322 and all waveguide segments 324 of SIG array 1300A are parallel.

SIG spectrometer 1390 may also include at least one of: a plurality of polarization-maintaining (PM) optical waveguides 1310, a plurality of polarizing beam-splitters (PBS) 1320, a plurality of single-mode (SM) optical fibers, a multi-mode-to-single-mode demultiplexer 1340, lens 360, and detector array 470. Hereinafter, multi-mode-to-single-mode demultiplexer 1340 is referred to as mode demultiplexer 1340, which may be a photonic lantern. PM optical waveguide 1310 may be an optical fiber or in integrated photonic waveguide. Multiplexer 1340 either (i) includes a respective distal end of each SM fiber 1330 or (ii) is optically coupled to each SM fiber 1330. SIG spectrometer 1390 may also include a multimode optical fiber 1350 coupled to an input port of multiplexer 1340.

While FIG. 13 illustrates SIG array 1300A as including twelve SIGs 400 arranged in a four-by-three array, SIG array 1300A may include a different number of SIGs 400 arranged in an array of a different shape without departing from scope of the embodiments herein. SIG array 1300A may be a rectangular array, as shown in FIG. 13, or may be a triangular or hexagonal array without departing from the scope hereof. SIG array 1300A may be on a single SIG chip.

Lens 360 may be directly above at least one of SIGs 400. The optical axis of lens 360 may intersect SIG array 1300A, e.g., either at part of a delay line of a SIG 400, a region between parts of delay line 320, or between two adjacent SIGs 400.

In an example mode of operation, each wavelength, of a plurality of wavelengths coupled to SIG array 1300A, and diffracted by each SIG 400 of SIG array 1300A to a respective angular direction, is focused by lens 360 to a respective one of a plurality of regions of detector array 470. The random phase of the emission of each SIG results in a time-varying speckle pattern that is spatially and temporally averaged by the detector pixels of detector array 470.

Each PBS 1320 is optically coupled to one SM optical fiber 1330 and to two PM optical waveguides 1310. For example, each PBS 1320 has (i) an input port coupled to a respective SM optical fiber 1330, (ii) a first output port coupled to a respective PM optical waveguide 1310, and (iii) a second output port coupled to a respective PM optical waveguide 1310. The first and second output ports may output a first linear polarization and a second linear polarization that is perpendicular to the first linear polarization. Accordingly, in embodiments, the number of SIGs 400 of SIG array 1300A is two times each of (i) the number of SM optical fibers 1330 optically coupled to SIG array 1300A and (ii) the number of PBS 1320 optically couples to SIG array 1300A.

Each SIG 400 includes a respective serpentine delay line 320, each of which has an input port 321. In embodiments, a respective proximal end of each PM optical waveguide 1310 is optically coupled to a respective input port 321. Each respective proximal end may be rotationally oriented, such that, at each input port 321, the fast axis of each of the plurality of PM waveguides 1310 is oriented in the same direction. Hence, while PBS 1320 has two output ports that output light with orthogonal polarizations to PM optical waveguides 1310, the light coupled from each PM optical waveguides 1310 into respective SIGs 400 have the same polarization. In embodiments, this polarization state is TE.

Each SIG 400 will emit the wavelength content to identical angles, but with the unique time-varying amplitude, phase, and mapped polarization component that was passed to it from the field of light propagating in the PM optical waveguide 1310 coupled to the SIG 400. The resulting emission pattern of tiled SIG array 1300A will be a time-varying speckle on the detector array 470, where the shape and central position of the envelope of this speckle is the diffraction limited focal spot of a single SIG 400.

This time-varying speckle can simply be averaged over some integration time by one or more pixels on detector array 470, resulting in all of the incident power being detected. Such a scheme also does not require more than one detector or additional post processing. Thus, a system that includes MMF 1350, multiplexer 1340, 2-D tiled SIG array 1300A, and a single shared lens 360 and 2-D detector array 470 will have no loss in resolution, and will have improved sensitivity and stability when imaging through atmospheric turbulence.

### 5B. Lensless Focusing SIG Spectrometer

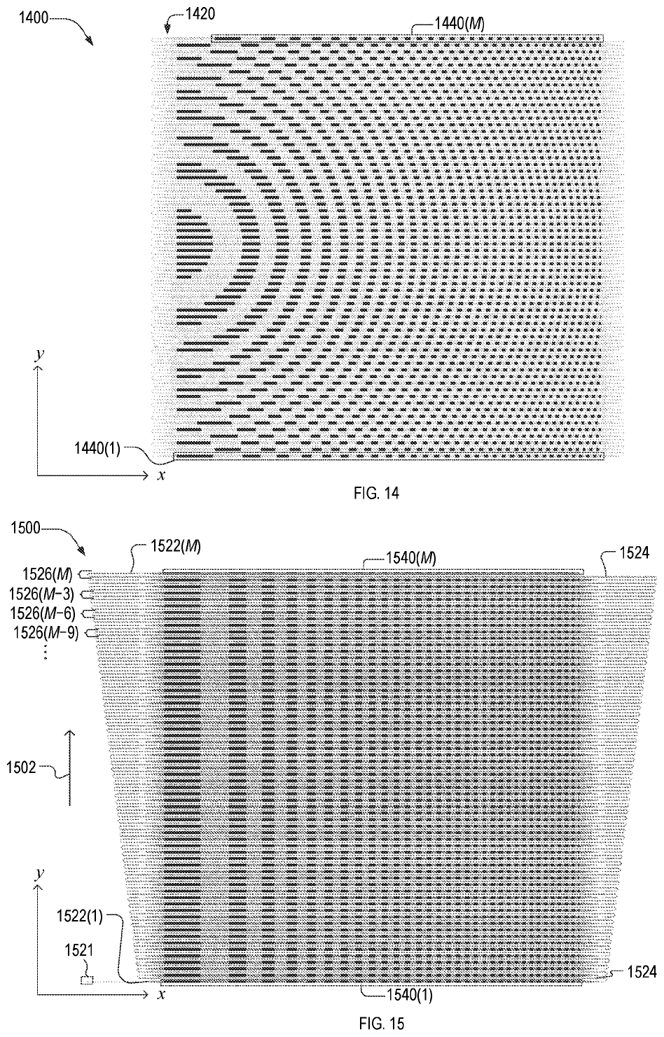

FIG. 14 is a schematic plan view of a focusing SIG 1400, which is an example of the SIG 400. SIG 1400 includes a serpentine delay line 1420 (shown in gray), M grating couplers 1440(1-M) (shown in black), which are respective examples of serpentine delay line 320 and grating coupler 340. Each grating coupler includes a plurality of diffractive elements 1442, each of which are examples of diffractive elements 342. While FIG. 14 illustrates each grating coupler 1440 as having approximately thirty diffractive elements 1442, each grating coupler 1442 may have at least one thousand diffractive elements 1442.

Each grating coupler 1440 may be integrated into a respective waveguide segment of delay line 1420. While FIG. 14 shows a grating coupler optically coupled to alternating waveguide segments of delay line 1420, SIG 1400 may include a respective grating coupler optically coupled to, e.g., integrated with, consecutive (immediately adjacent) waveguide segments of SIG 1400. For clarity of illustration, not all grating couplers 1440 are labeled in FIG. 14.

In each grating coupler 1440, the grating periodicity (along the x-axis) is varied linearly and, row-to-row starting phase is varied quadratically to create a 2D quadratic phase factor that focuses the emitted light. The row-to-row starting phase refers to the starting phase as a function of direction y across grating couplers 1440. Proper scaling of the quadratic phase factor along the x and y directions both aligns the focal length of SIG 400 along each direction and eliminates astigmatism, and is verified by the apparent circular 2D circular fringes visible in FIG. 14. Focusing SIG 1400 radiates a focusing beam and acts as both a crossed-dispersion emitter and a focusing lens, as shown in FIG. 14.

When each SIG 400 of SIG spectrometer 490 is a focusing SIG 1400, or when each SIG 400 of SIG spectrometer 1390 is a focusing SIG 1400, the resulting spectrometer is a focusing SIG spectrometer. A focusing SIG spectrometer has three main advantages: 1) the system can be further miniaturized because lens 360 is not required and hence not included, 2) SIG 1400 and detector array 470 may be bonded together or otherwise attached by a transparent layer such as a glass prism for a sturdier construction, and 3) the bandwidth can be increased by using a high refractive index interface material that increases the NA and also decreases the angular dispersion.

Examples of the transparent layer between SIG 1400 and detector array include a prism, a bi-planar substrate, a transparent adhesive, or a combination thereof. The layer may have a high-refractive index, e.g., exceeding 1.6 or 2.0.

Along the grating (x) dimension, the grating frequency of focusing SIG 1400 is varied linearly as represented by a quadratic phase factor. The grating frequency may be varied according to as in eq. (8).

$$p ( x ) = [ cos ( \frac{2 π x}{{Λ}_{x}} + π {b}_{x} {x}^{2} ) > 0 ] Π ( x / L ) , \qquad ( 8 )$$

In eq. (8), bₓ is a spatial chirp rate along the grating of length L that is added to the central period Λₓ to incorporate the focusing quadratic phase function.

In embodiments, a quadratic emission phase is created in the y-dimension by varying the starting phase of the quadratic phase function of each row. As a function of y, the guided field emitted at each grating tooth of grating coupler 1440 is proportional to:

$$q ( y ) = {\sum }_{m = 0}^{M - 1} {e}^{- j [ m ϕ ( ω ) + π {{b}_{y} ( m - \frac{M}{2} )}^{2} {Λ}_{y}^{2} ]} a ( y - m {Λ}_{y} ) , \qquad ( 9 )$$

where SIG 1400 has M rows spaced by Λ_{y} with modal profile a(y), indices m, and spatial chirp rate b_{y}. The focal lengths are

$${z}_{x} = \frac{{n}_{bulk}}{λ {b}_{x}}$$

in the x-z plane and

$${z}_{y} = \frac{{n}_{bulk}}{λ {b}_{y}}$$

in the y-z plane, where n is the refractive index of the medium above SIG 1400, e.g., between SIG 1400 and detector 470. Each of the focal lengths may be less than one centimeter allowing for an extremely compact design, especially using a solid glass prism between SIG 1400 and detector 470. The spatial chirp rates may equal (bₓ=b_{y}) to prevent astigmatic focusing and achieve high diffraction limited spectral resolution.

The focal lengths are proportional to frequency of the diffracted light, which results in a focal plane that tilts versus frequency. In embodiments, SIG spectrometer 490 includes a tip-tilt stage 474, such that detector array 470 may be tilted in at least one of (i) the x-dimension (about an axis perpendicular to the x axis) and (ii) a tilt in the y-dimension (about an axis perpendicular to the y axis) to accommodate this frequency-dependent focal length, and to keep the spots of imaged-spot array in focus. In embodiments, the maximum attainable tilt in the y dimension is zero or smaller than the maximum attainable tilt in the x direction. Detector array 470 may be attached, e.g., removably attached, to tip-tilt stage 474.

### 5B.1 Focusing Grating SIG

To further simplify the optics of the SIG array spectrometer, a grating with focusing power based on an incorporated quadratic phase factor (QPF) in the out-coupling waveguide may be used to eliminate the required achromatic large NA low-aberration lens. The high-resolution micro-spectrometer can then be implemented with a single focusing SIG array and an appropriately tilted 2-D detector array with either free space of possibly liquid or solid immersion layer of index n_{bulk}. This further reduces the out-coupling angles and increases the achievable bandwidth and number of resolvable spots by about n_{bulk}. In the slow-scan direction the central frequency of the grating may be varied linearly along each SIG-array row with a quadratic-phase grating function

$${e}^{i ( {K}_{g} x + π {b}_{x} {x}^{2} )} ,$$

with spatial chirp rate bₓ and central period Λₓ=2π/K_{g}. To lower the sidelobes we can also include a Gaussian apodization along the rows b(x)=e^{-(x/σ)}^{²} (and to simplify the analysis we will neglect the truncation due to the finite row length). This leads to an out-coupled angular spectrum along the rows at optical angular frequency ω=2πv:

$$E ( {K}_{y} , ω ) \approx δ ( {k}_{x} - ( {K}_{g} - β ( ω ) ) ) * \frac{1}{\sqrt{i {b}_{x}}} {e}^{- \frac{{k}_{x}^{2}}{{( 2 π {b}_{x} σ )}^{2}}} {e}^{i π \frac{{k}_{x}^{2}}{{( 2 π {b}_{x} )}^{2}}} . \qquad ( 10 )$$

This Gaussian apodized beam will propagate in free space in a region with wavevector k₀ towards a focus (or in an immersion medium with index n we can interpret

$${k}_{0} = \frac{n ω}{c} ) .$$

We can Fresnel approximate the free-space transfer function as

$$T ( {k}_{x} , {k}_{y} ) = {e}^{{ik}_{0} z} {e}^{- i \frac{{k}_{x}^{2} + {k}_{y}^{2}}{2 c} ω z} ,$$

allowing us to solve for the focal distance along x as

$${z}_{c} = \frac{ω}{c π {b}_{x}} .$$

This illustrates that there will be a linear variation of focal distance with frequency which can be mostly accounted for by appropriately tilting the detector array.

In the orthogonal direction we can incorporate a sampled focusing grating across the rows in two distinct ways, either by varying the starting phase of the QPF, as illustrated by focusing SIG 1400 (FIG. 14), along the rows, or alternatively as a true-time-delay frequency dependent quadratic phase by linearly increasing the fixed delay from row to row such as shown in FIG. 15.

FIG. 15 is a plan view of a focusing SIG 1500, which is an example of the SIG 400. SIG 1500 includes a serpentine delay line 1520 (gray) and M grating couplers 1540, which are respective examples of serpentine delay line 320 and grating coupler 340. Delay line 1520 includes an input port 1521 and a plurality of waveguide segments 1522(1, 2, . . . , M) and a plurality of flyback waveguide segments 1524, which are respective examples of input port 321, waveguide segments 322, and flyback waveguide segments 324. Each grating coupler 1540 may be integrated into a respective waveguide segment 1522 of delay line 1520. In embodiments, focusing SIG 1500 includes M grating couplers 1540, each of which is optically coupled to, and/or integrated with, a respective waveguide segment 1522.

In terms of path length of light propagating along delay line 1520 from input port 1521 and each grating coupler 1540(k=1, 2, . . . , M), the path length increases with increasing k. FIG. 15 denotes M segment pairs 1526, each of which includes a waveguide segments directly adjacent to a flyback waveguide segment 1524. The length of waveguide segment 1522 in each segment pair 1526(k=1, 2, . . . , M) increases linearly as a function of k, which induces a quadratic phase factor from row to row. For clarity of illustration, not all waveguide segments 1522, segment pairs 1526, and grating couplers 1540 are labeled in FIG. 15.

In focusing SIG 1400, the chromatic variation of focal length along the rows may be matched, such that the array factor from row to row (again including an optional Gaussian apodization) is

$$E ( y ) = {\sum }_{m = 0}^{M - 1} a ( y - m {Λ}_{y} ) {e}^{- i [ m ϕ ( ω ) + π {{b}_{y} ( m - \frac{M}{2} )}^{2} ]} {e}^{i {\sum }_{{m}^{′} = 0}^{m} {ϕ}_{{m}^{′}}} {e}^{- {( \frac{m - M / 2}{{σ}_{y}} )}^{2}} . \qquad ( 11 )$$

This gives a focal distance z_{f}=Λ_{y}²/λb_{y} along this row-to-row dimension. The focusing power along this axis is limited by the Nyquist sampling criteria with a maximum row-to-row phase shift at the edges of π, which gives a maximum sampled chirp factor

$${b}_{max} = \frac{1}{M} ,$$

which corresponds to a sampled spatial quadratic phase factor b_{y}^{m}=1/MΛ_{y}². Thus, the minimum achievable focal distance along this dimension, z_{f}=MΛ_{y}²/λ will also be proportional to frequency but will be different from the distance calculated for the QPF grating along x, x. This would produce unwanted astigmatic focusing unless we set the two quadratic phase factors (and resulting focal lengths) equal, and choosing the maximum chirp rate allowed by the spacing of the rows gives b_{y}=b_{y}^{m}, and

$${z}_{min} = M {Λ}_{y}^{2} / λ = \frac{M {Λ}_{y}^{2} ω}{2 π c} .$$

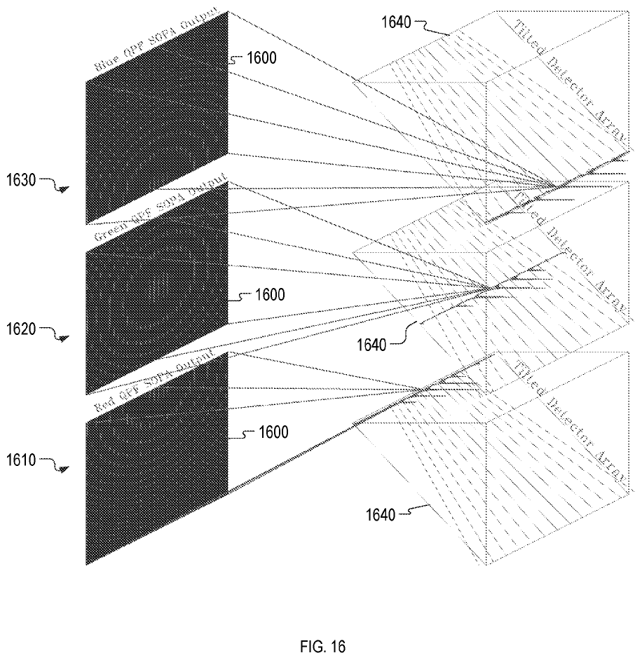

FIG. 16 shows the focusing of such an isotropic quadratic phase factor SIG array 1600 at three different wavelengths across a nominal operating band from 1300 nm-1600 nm. The three wavelengths are 1600 nm (diagram 1610, −17°), 1450 nm (diagram 1620, 0°), and 1300 nm (diagram 1630, +17°), with a focal distance proportional to the optical frequency which is accommodated for by appropriately tilting a detector array 1670. Detector array 1670 is an example of detector array 470. The focal length of SIG array 1600 varies in proportion to the frequency and the central angle varies as in the linear grating SIG array. This may be accommodated by tilting the detector array 1670 to keep the spots nominally in focus, which requires a large tilt in the slow-scan direction (coarse resolution), and a small, nearly-negligible, tilt in the fast-scan direction (fine resolution).

Alternatively, when the operating bandwidth is not centered on diffraction normal to SIG array 1600, both SIG array 1600 and detector 1670 may be tilted. Since the scale factor of the spatial dispersion will vary with the focal length across the tilted detector array 1670 in both the fast and slow scan directions, the spectrum will be mapped onto the 2-D array with a type of keystone distortion, as illustrated by the wedge-shaped segments on tilted detectors 1640.

In an embodiment, SIG array 1600 is a 0.6-mm² (0.77×0.77 mm) SIG-array device with M=128 rows and 6-μm row spacing (3.5-μm grating waveguide, 1.5-μm wide flyback waveguides and 0.5-μm waveguide spacing). In this embodiment, the minimal (Nyquist limited) isotropic focal lengths would vary from about 7.7 mm to 5.4 mm as the wavelength varies from 1200 nm to 1700 nm. When this embodiment of SIG array 1600 is designed for normal outcoupling at 1450 nm with a grating pitch of Λ=0.53 μm, the scan angle will vary from −29° to +300 over this wavelength range (neglecting the GVD). This leads to a detector tilt of 16.5° and a length of 6.75 mm along this tilted detector. The grating lobe spacing at 1200 nm is 11.5°, which projects onto 1.09 mm on the detector and at 1700 nm, the lobe spacing is 16.5°, which projects onto 2.22 mm on tilted detector array 1670.

In embodiments, space between SIG array 1600 and tilted detector 470 is filled with a high index material (of index n). The high-index material decreases deflection angles emitted by SIG array 1600 while increasing focal lengths. The high-index material allows not only a rigid support structure but also an operating wavelength range increased by about n. Bonding SIG array 1600 and tilted detector 470 to an appropriate high-index glass prism would increase the fractional bandwidth captured by the detector from only about one third to over half, while allowing a robust and compact package less than a cubic cm³ for this high-resolution microspectrometer with resolving power of over 10⁵ due to the nearly 20 cm of folded path length in the SIG array with group delay over a nanosecond and corresponding sub-GHz resolution capabilities.

### 5C. Delay-Corrected, Two-Level SIG

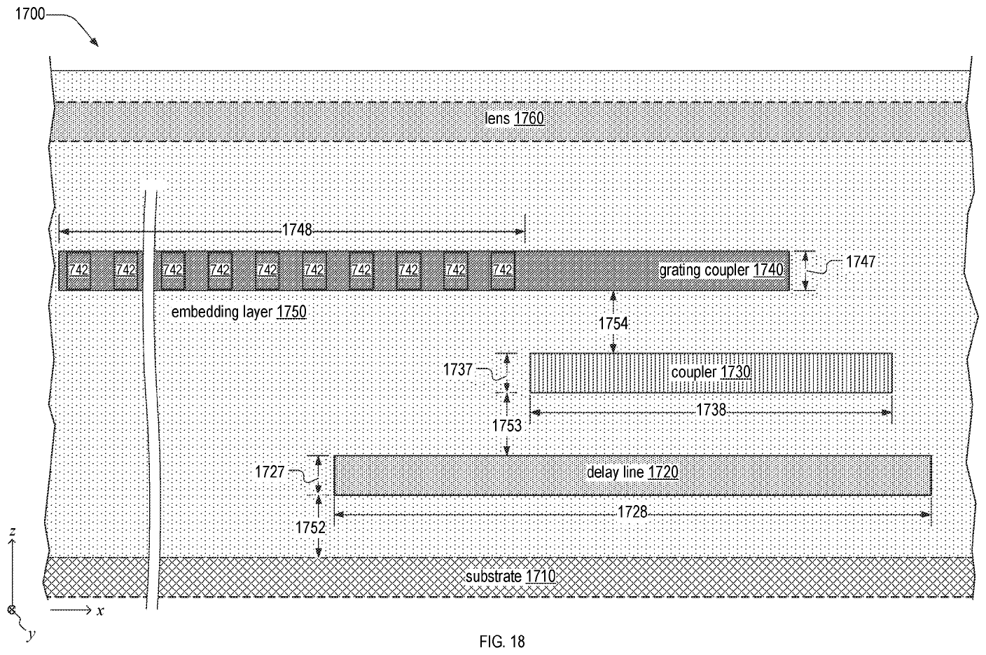

FIG. 17 is a schematic of a multi-level SIG 1700, which is an example of SIG 700. FIG. 18 is a cross-sectional view of multi-level SIG 1700. FIGS. 17 and 18 are best viewed together in the following description.

SIG 1700 includes at least one of: a grating coupler 1740, a serpentine delay line 1720, a coupler 1730, and an embedding layer 1750. For clarity of illustration, FIG. 17 does not illustrate embedding layer 1750. SIG 1700 may also include an integrated photonics lens 1760 formed on a layer above grating coupler 1740. Lens 1760 may be a Fresnel lens, and is an example of lens 360.

Delay line 1720 has a plurality of waveguide segments 1722, each which has a length 1728. Segments 1722 and length 1728 are examples of waveguide segment 322 and length 328 respectively. The cross-sectional plane of FIG. 18 intersects one grating coupler 1740, one waveguide segment 1722, and one coupler 1730 therebetween. SIG 1700 includes an adiabatic variable-coupling structure (including couplers 1730) from serpentine delay line 1720 up to a waveguide emission layer that includes grating couplers 1740. Such a structure enables factor F<<1.

Delay line 1720 and grating coupler 1740 are respective examples of delay line 320 and grating coupler 740. Without departing from the scope hereof, grating coupler 1740 may be replaced with a grating of a different type, other than double sidewall, such as those mentioned in the description of grating coupler 340.

Coupler 1730 may be an adiabatic coupler that includes an adiabatic taper at either one end or both ends. Each taper may be between 50 micrometers and 150 micrometers long, such that, in embodiments, a length 1738 of coupler 1730 is at least 50 micrometers. Each taper may be shorter than 50 micrometers without departing from the scope hereof. The profile of the taper may be linear or nonlinear, such as quadratic, sigmoid, or Dolph-Chebyshev. Along the y direction, coupler 1730 has a maximum width that, in embodiments, is between three micrometers and five micrometers. The maximum width of coupler 1730 may equal the width of waveguide segment 1722 directly beneath it.

SIG 1700 may include a substrate 1710, upon which delay line 1720 is disposed, as shown in FIG. 18. Along the z direction, delay line 1720, coupler 1730, and grating coupler 1740 have respective thicknesses 1727, 1737, and 1747, and are separated by respective distances 1753 and 1754. Delay line 1720 is located at distance 1752 above substrate 1710. Each of thicknesses 1727, 1737, and 1747 may be between forty nanometers and 400 nanometers. Each of distances 1752, 1753, and 1754 may be between zero and 0.7 micrometers. In embodiments, at least one distances 1752, 1753, and 1754 is between 50 nanometers and 550 nanometers, for example between 450 nanometers and 550 nanometers. Anyone of distances 1752, 1753, and 1754 may equal zero.

Coupler 1730 may be formed of silicon or a silicon nitride, such as Si₃N₄, or more generally a high-index material. Embedding layer 1750 may be formed of a low-index material, such as silicon dioxide. Examples of low-index materials are those with a refractive index that less than that of silicon and/or Si₃N₄. Delay line 1720 and grating coupler 1740 may be formed of different materials. In embodiments, delay line 1720 is formed of silicon, and grating coupler 1740 is formed of a silicon nitride.

Coupler 1730 taps out a small fraction of the serpentine delay line light from each waveguide segment 1722. By adiabatically varying the strength of the coupling through the layers, broadband operation can be achieved. By varying the length of coupler 1730, the required coupling strength to grating coupler can be achieved. Grating coupler 1740 includes a plurality of diffractive elements 342, which span a length 1748. Diffractive elements may be periodic or chirped. In embodiments, at least part grating coupler 1740 and at least part of serpentine delay line 1720 are on different layers, such that grating length 1748 is decoupled from the row-to-row delay determined by length 1728, as shown in FIG. 20 below. This decoupling of length 1748 from length 1728 enables improved spectrometer performance without increasing the chip footprint.

In embodiments, delay line 1720 and grating couplers 1740 are placed on separate design layers, connected by weakly-coupled layer transitions with variable couplers 1730 tapping approximately 1/(M−j) the power in the jth row of M total rows (delivering 1/M of the power to each row), to decouple the grating length from the delay length. Embodiments of this modified design have several benefits. First, the grating length 1748 along each row may be much greater than each of length 1728, such that factor F is less than one, e.g., less than 0.5 and/or 0.3 as discussed above. This difference, along with Gaussian apodization of the emission profiles along the grating coupler dimension, can ensure that subsequent row-to-row FSRs are sufficiently angularly separated along the grating dimension to minimize crosstalk.

Second, the two-level design may use stronger scattering grating coupler designs to fully extract the light from each row rather than weakly-scattering grating couplers, which only extract a fraction of the light per row. Emission of all the tapped light per row in each respective grating improves emission efficiency.

Third, the use of coupler 1730 to couple between delay line 1720 and grating couplers 1740 allows the total emission strength of each row to be controlled by coupler 1730 rather than the corrugation dept of grating coupler 1740. This will also help simplify the grating coupler apodization scheme, because the grating couplers will only need to be apodized along one dimension instead of two.

FIGS. 17 and 18 illustrates each of serpentine delay line 1720, variable coupler 1730, and grating coupler 1740 at different respective heights above substrate 1710 in the z direction. In such embodiments, at least two of these components may be formed of the same material or be formed of different materials. In embodiments, at least two of these components may be at the same height above substrate 1710 such that they are laterally adjacent, and coplanar, in a plane parallel to the x-y plane. In such embodiments, at least two of these components may be formed of the same material.

### 6. Serpentine Grating Pulse Shaper

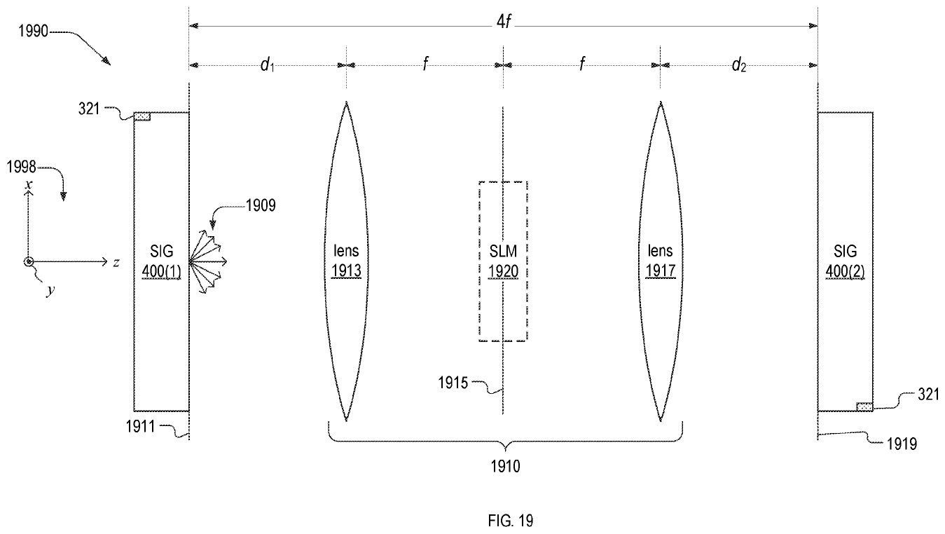

FIG. 19 is a schematic of a two-dimensional crossed-dispersive SIG pulse-shaper 1990 shown in a transmissive spatial light modulator (SLM) implementation. SIG pulse-shaper 1990 has sufficient resolving power and built in time delay to replace the bulk optics hyperfine systems in a dramatically simplified and miniaturized. ultrafast pulse shaper. Such a pulse shaper has higher resolution than typical 1-D pulse shapers.

SIG pulse-shaper 1990 includes an input SIG 400(1), an output SIG 400(2), and a 4f system 1910. 4f system 1910 may be at least one of symmetrical and an afocal telescoping imaging system. Each of SIGs 400(1) and 400(2) may be an embodiment of SIG 700. SIG pulse-shaper 1990 may also include a two-dimensional SLM 1920. 4f system 1910 is between SIGs 400(1) and 400(2). Each of SIGs 400 is an example of SIG 400. SIG pulse-shaper 1990 may also be implemented using a reflective SLM and a single SIG device 400 as both the transmitter and receiver device.

FIG. 19 denotes an x-y-z coordinate system 1998, where the optical axes of lenses 1913 and 1917 are collinear with z. In embodiments, SIGs 400(1) and 400(2) are rotationally aligned, such that they have the same rotational orientation in the x-y plane. For example, in each of SIGs 400(1) and 400(2), waveguide segments 322 are parallel to the x axis.

4f system 1910 includes a lens 1913 and a lens 1917 separated by a distance 2f, where f is the focal length of lenses 1913 and 1917. FIG. 1990 denotes an object plane 1911, an image plane 1919, and a Fourier plane 1915 of 4f system 1910. SIGs 400(1) and 400(2) are located at an object plane 1911 and an image plane 1919, respectively. In embodiments, grating couplers of SIG 400(1) intersect object plane 1911, and grating couplers of SIG 400(2) intersect image plane 1919. SLM 1920 is at Fourier plane 1915. Along the z direction, object plane 1911 is spaced from a principal plane of lens 1913 by a distance d₁, and object plane 1911 is spaced from a principal plane of lens 1917 by distance d₂, where d₁+d₂=f.

4f system 1910 forms (i) an image of SIG 400(1) in image plane 1919 and (ii) an image of SIG 400(2) in object plane 1911. In embodiments, SIG 400(2) is positioned and oriented as a conjugate of SIG 400(1), such that SIG 400(2) is located at the image of SIG 400(1). Hence, SIG 400(2) is flipped both about the x axis and the y axis relative to SIG 400(1), and translated a distance 4f along the z direction.

In an example mode of operation, a two-dimensional angular beam pattern 1909 from SIG 400(1) is afocally imaged by 4f system 1910 onto a SIG 400(2). Angular beam pattern 1909 is an example of angular beam pattern 409. SLM 1920 modulates (either amplitude and/or phase) individual spectral components that are focused by lens 1913. In embodiments, SIGs 400(1) and 400(2) include 100 serpentine rows in a 1-mm×1-mm aperture, and emit a wide spectral bandwidth over a ±30° angular range, each of lenses 1913 and 1917 has an f-number less than or equal to one, e.g., (f=1 cm, diameter D=1 cm), and SLM 1920 has between 10⁵ and 10⁶ pixels (in a square array, such as 1000×1000 pixels), where the pixel size is between of three micrometers and ten micrometers. In such embodiments, 4f system 1910 will focus the various spectral components to 10-micron spots in a 2-D folded spectrum array well matched to SLM 1920.

SLM 1920 in Fourier plane 1915 allows modulation of individual spectral components of angular beam pattern 1909. Amplitude modulating SLM 1920 weights and picks individual spectral components sent to SIG 400(2). Phase modulating SLM 1920 for dispersion control yields pulse-compressed output received and output by SIG 400(2). Modulating SLM 1920 in both amplitude and phase enables arbitrary pulse shaping of angular beam pattern 1909.

In embodiments, SIG 400(1) is coupled to a comb source, which produces angular beam pattern 1909. The repetition rate of the comb source may be between 1 and 10 GHz. In such embodiments, line-by-line pulse shaping (line-by-line modulation using pixels of SLM 1920) to modulate corresponding frequency components allows arbitrary waveform generation. Nanosecond time delay τ_{y} allows overlap of shaped pulses into continuous wave arbitrary waveforms repeating at the repetition rate.

Turning on the transmittance of one pixel of SLM 1920 will allow only a single monochromatic component of angular beam pattern 1909 to pass through to SIG 400(2), where it will arrive with the correct wavefront shape and tilt to coherently couple into the receive serpentine waveguide rows of SIG 400(2) with the exact phase at each coherent coupler necessary to yield a coupling efficiency exactly equal to the diffraction efficiency of the SIG 400(1) into that grating lobe spectral order. Turning on a collection of equi-spaced pixels of SLM 1920 at the locations corresponding to the grating lobes along a fast scan row of SLM 1920 will increase the system throughput and produce a well resolved image of the waveguide segments 322 of SIG 400(1) precisely on the waveguide segments 322 of SIG 400(2). By reciprocity, the coupling efficiency into the backwards propagating serpentine waveguide mode (of delay line 320 of SIG 400(2)) equals full out-coupling efficiency of SIG 400(1).

In embodiments of SIG 400, at least one of: (i) grating coupler 340 is unidirectional grating that is tapered and apodized or optimal Gaussian profiled beam light extraction, and (ii) pitch 347 is at its lower bound, within design rules and to avoid inter-row coupling for example, given any extent of diffractive elements 342 along the y direction between adjacent waveguide segments 322. Each of these features, when implemented in both SIG 400(1) and 400(2), increase diffraction efficiency into the central grating lobe. This would allow a SIG pulse-shaper 1990 to achieve 6-12 dB throughput when only phase modulating the various spectral components, and higher efficiencies when the grating lobes are also transmitted and appropriately phase modulated in proportion to the lobe order and added coherently.

For a comb source with multi-GHz repetition rate coupled to SIG 400(1), a slightly-tilted 2-D rectangular bed of nails optical spots will be produced in Fourier plane 1915, requiring a corresponding slight rotation of SLM 1920 to align the SLM pixels to the comb orders. With longer grating waveguide row propagation delay time than serpentine row-to-row delay time (F<0.3-0.5), there may be a few unused pixels in between successive tilted fine orders in the coarse direction. In embodiments, pixels of SLM 1920 in between the spectral loci are masked off, and SLM 1920 has phase modulating (or both amplitude and phase modulating) capabilities for the pixels precisely aligned with the comb orders. For a specific comb repetition rate, a specific achromatic (or preferably apochromatic) focal length and serpentine row spacing and grating pitch ratio would be required to match the pixel pitch along both axes.

FIG. 20 is a plan view of a multi-level focusing SIG 2000, which is an example of the SIG 1700 of FIG. 17, and hence is also an example of SIG 700 and SIG 400. SIG 2000 includes a serpentine delay line 2020 (gray), M variable couplers 2030(1-32) (black), M grating couplers 2040(1-32) (black), which are respective examples of serpentine delay line 1720, variable coupler 1730, and grating coupler 1740. Multi-level focusing SIG 2000 may include embedding layer 1750. Each grating coupler 2040 may be a chirped-grating coupler, as illustrated in FIG. 20, or may be a fix-frequency-grating coupler.

Serpentine delay line 2020 includes 32 waveguide segments 2022 and 31 flyback waveguide segments 2024, each of which is an example of waveguide segment 322 and flyback waveguide segment 324 respectively. While M=32 in the embodiment of FIG. 20, M may be greater than or less than 32 in other embodiments of SIG 2000. Similarly, serpentine delay line 2020 may have fewer than or more than 65 waveguide segments without departing from the scope hereof. For clarity of illustration, not all of waveguide segments 2022, variable couplers 2030, grating couplers 2040 are labeled in FIG. 20.

As in SIG 1400, FIG., 14, the periodicity of grating couplers 2040 along x is varied linearly and, the row-to-row starting phase is varied quadratically along y to create a 2D quadratic phase factor that focuses the emitted light. The periodicity of grating couplers 2040 may be varied according to eq. (8), and the row-to-row starting phase may be varied according to eq. (9). The row-to-row starting phase refers to the starting phase as a function of direction y (and row numbers {1, 2, . . . , M}) across the plurality of grating couplers, e.g., grating couplers 2040.

Delay line 2020 has an input port 2021, which is an example of input port 321. In terms of path length of light propagating along delay line 2020 from input port 2021 and each coupler 2030(k=1, 2, . . . , M), the path length increases with increasing k. If each of couplers 2030 had the same length and coupling strength, the intensity of light coupled from coupler 2030(k) to grating coupler 2040(k) would decrease exponentially as index k increases from 1 to M because of light diffracted by each of previous grating couplers 2040(1, 2, . . . , k−1). In embodiments, and as illustrated in FIG. 20, the length and coupling strength of variable couplers 2030 increases monotonically from coupler 2030(1) to coupler 2030(32). This variation in coupler length increases the uniformity of light diffracted from grating couplers 2040(1-32). In embodiments, the coupling strength and/or length of coupler 2030(k) is proportional to 1/(M−k) to equalize output of each grating coupler 2030.

Varying the lengths of couplers 2030 may also result in beneficial apodization of the aforementioned high-diffraction-order echelle-like structure oriented in the y direction. In embodiments, the length of variable couplers 2030 is varied to balance a tradeoff between uniformity of emission and said apodization.

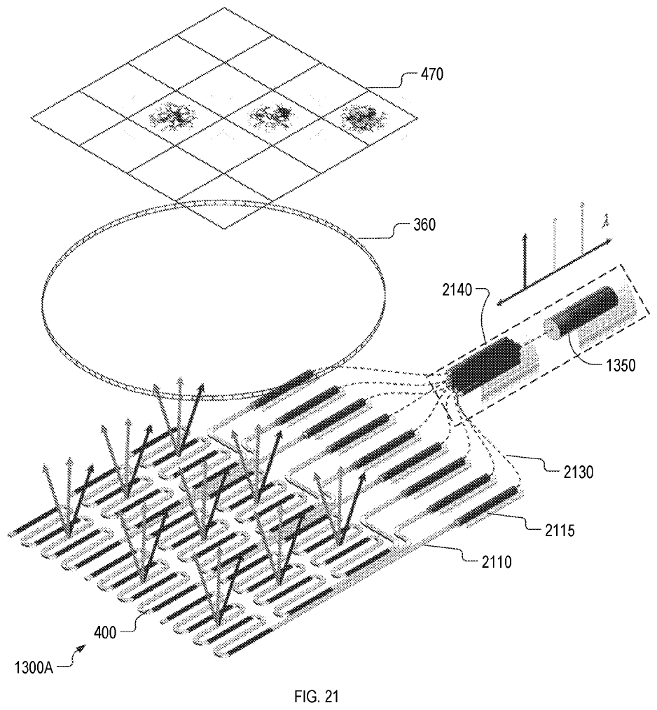

FIG. 21 is a schematic of a SIG spectrometer 2090, which is an example of SIG spectrometer 1390, FIG. 13. Spectrometer 2090 includes tiled SIG array 1300A, a plurality of single-mode integrated photonic waveguides 2110, a plurality of fiber-to-chip couplers 2115. Spectrometer 2090 may also include at least one of a plurality of SM fibers 2130, a mode multiplexer 2140, and multimode optical fiber 1350. Waveguides 2210, SM fibers 2130, and demultiplexer 2140 are respective examples of PM waveguides 1310, SM optical fibers 1330, and mode demultiplexer 1340. Each single-mode integrated photonic waveguides 2110 is optically coupled to a respective SIG 400 at its input port 321. Each fiber-to-chip coupler 2115 couples a single-mode integrated photonic waveguide 2110 to a respective SM fiber 2130. Mode demultiplexer couplers multimode optical fiber 1350 to SM fibers 2130. SIG spectrometer 2090 may include a plurality of polarizing beam-splitters PBS 1320, each of which couples a SM fiber 2130 to two single-mode integrated photonic waveguides 2110, as in SIG spectrometer 1390.

Changes may be made in the above serpentine integrated gratings and spectrometers without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present serpentine integrated grating spectrometer method and system, which, as a matter of language, might be said to fall therebetween.
¹ Z. Yang, T. Albrow-Owen, W. Cai, and T. Hasan, “Miniaturization of optical spectrometers,” Science 371, eabe0722 (2021).

1. A serpentine integrated grating:
a serpentine delay line that includes a plurality of parallel waveguide segments that are coplanar in a delay-line plane; and
a plurality of grating couplers that are serially connected by the serpentine delay line, each of the plurality of grating couplers (i) is located at a respective one of the plurality of parallel waveguide segments, and (ii) direct light propagating in the serpentine delay line out of the delay-line plane,
the plurality of waveguide segments being in M in number and imparting a total group delay time τ_{y} on light propagating therethrough, each of the plurality of grating couplers imparting a grating coupler delay τₓ on light propagating therethrough that exceeds (τ_{y}/M), the time delay for a single segment of the M parallel segments.

2. The serpentine integrated grating of claim 1, each of the plurality of grating couplers being integrated into a respective one of the plurality of parallel waveguide segments.

3. The serpentine integrated grating of claim 1, grating coupler delay τₓ exceeding (τ_{y}/M) by at least a factor of two.

4. The serpentine integrated grating of claim 1, each of the plurality of grating couplers including one of a sidewall grating, a SiN overlay grating, unidirectional grating, an apodized width grating, a pulse-width-modulated apodized-length grating, and any combination thereof.

5. The serpentine integrated grating of claim 1, at least part of each of the plurality of grating couplers being located directly above a respective one of the plurality of waveguide segments, and further comprising:
a plurality of optical couplers each located between a respective one of the plurality of waveguide segments and a respective one of the plurality of grating couplers located thereabove.

6. The serpentine integrated grating of claim 5, each of the plurality of grating couplers (i) being longer than the waveguide segment, of the plurality of waveguide segments, located directly beneath and (ii) including a grating section that is not directly above the waveguide segment.

7. (canceled)

8. The serpentine integrated grating of claim 1, at least part of each of the plurality of grating couplers being located directly above a respective one of the plurality of waveguide segments in a direction parallel to the delay-line plane.

9. The serpentine integrated grating of claim 1, each of the plurality of parallel waveguide segments being parallel in a row direction and adjacent to one another in a column direction that is perpendicular to the row direction.

10. The serpentine integrated grating of claim 9, a pitch of the plurality of parallel waveguide segments in the column direction exceeding a grating period of each of the plurality of grating couplers in the row direction.

11. The serpentine integrated grating of claim 9, in the column direction, a pitch of the plurality of parallel waveguide segments equaling a pitch of the plurality of grating couplers.

12. The serpentine integrated grating of claim 1, the serpentine delay line and the plurality of grating couplers forming a first serpentine integrated grating (SIG), and further comprising:
a plurality of SIGs that includes the first SIG and form a SIG array.

13. The serpentine integrated grating of claim 12, each of the plurality of SIGs having a respective one of a plurality of input ports, and further comprising, at each of the plurality of input ports:
a respective one of a plurality of polarization-maintaining (PM) waveguides optically coupled to the input port.

14. The serpentine integrated grating of claim 13, at each input port of the plurality of input ports, a proximal end of the PM waveguide of the plurality of PM waveguides being coupled to the input port and being rotationally oriented, such that, at the plurality of input ports, each of the plurality of PM fibers has a fast axis oriented in a same direction.

15. The serpentine integrated grating of claim 14, further comprising:
a plurality of single-mode (SM) optical fibers; and
a plurality of polarizing beam-splitters each having (i) an input port coupled to a respective one of the plurality of SM optical fibers, (ii) a first output port coupled to a respective one of the plurality of PM waveguides, and (iii) a second output port coupled to a respective one of the plurality of PM waveguides.

16. The serpentine integrated grating of claim 15, the plurality of SIGs being 2N in number, each of the plurality of SM fibers and polarizing beam-splitters being N in number.

17. (canceled)

18. A serpentine integrated grating spectrometer comprising:
the serpentine integrated grating of claim 1;
a lens located directly above the serpentine delay line; and
a detector array located at a back focal plane of the lens, the lens being between the detector array and the serpentine delay line.

19. A serpentine integrated grating spectrometer comprising:
the serpentine integrated grating of claim 1, in which each of the plurality of grating couplers has grating period that varies linearly, and the plurality of grating couplers form a one-dimensional grating-coupler array having a quadratically-varying starting phase across the grating-coupler array, such that the grating coupler array both focuses and diffracts light propagating in the serpentine delay line, and
a detector array located at a focal plane of light focused by the plurality of grating couplers.

20. (canceled)

21. A pulse shaper comprising:
a 4f imaging system;
a first serpentine integrated grating of claim 1, located at an object plane of the 4f imaging system;
a second serpentine integrated grating of claim 1, located at an image plane of the 4f imaging system, and oriented as a conjugate of the first serpentine integrated grating; and
a spatial light modulator at a Fourier plane of the 4f imaging system.

22. A serpentine integrated grating comprising:
a serpentine delay line that includes a plurality of parallel waveguide segments intersecting a delay-line plane;
a plurality of grating couplers that are serially connected by the serpentine delay line, at least part of each of the plurality of grating couplers being located directly above a respective one of the plurality of waveguide segments; and
a plurality of optical couplers each located between a respective one of the plurality of waveguide segments and a respective one of the plurality of grating couplers located thereabove.

23. The serpentine delay line of claim 22, each of the plurality of grating couplers being longer than the waveguide segment, of the plurality of waveguide segments, located directly beneath.
